(19) United States
(12) Patent Application Publication
(10) Pub. No.: US 2025/0089035 A1
(43) Pub. Date: Mar. 13, 2025

(54) CROSS DIVISION DUPLEX (XDD) SYSTEM FOR BANDWIDTH PART (BWP) SWITCHING AND RESOURCE CONFIGURATION

(71) Applicant: Samsung Electronics Co., Ltd., Suwon-si (KR)

(72) Inventors: Juyeong LEE, Suwon-si (KR); Heedon Gha, Suwon-si (KR)

(73) Assignee: Samsung Electronics Co., Ltd., Suwon-si (KR)

(21) Appl. No.: 18/921,943

(22) Filed: Oct. 21, 2024

Related U.S. Application Data
(63) Continuation of application No. PCT/KR2023/002578, filed on Feb. 23, 2023.

(30) Foreign Application Priority Data
Apr. 21, 2022 (KR) 10-2022-0049649
May 9, 2022 (KR) 10-2022-0056335

(51) Int. Cl. H04W 72/0457; H04L 1/1812; H04L 5/14; H04W 72/0453; H04W 72/1273; H04W 72/231

(52) U.S. Cl. CPC H04W 72/0457; H04L 1/1812; H04L 5/14; H04W 72/0453; H04W 72/1273; H04W 72/231

(57) ABSTRACT

A method of a terminal, includes: receiving first DL BWP configuration information comprising an ID of a first DL BWP; receiving first UL BWP configuration information comprising an ID of a first UL BWP; receiving, from the base station, second DL BWP configuration information comprising an ID of a second DL BWP and an ID of a second UL BWP; and recognizing, through the ID of the second UL BWP, that the second DL BWP configuration information is information for DL-UL configuration of the terminal, wherein, in a first slot, when the first DL BWP and the first UL BWP are temporally separated from each other, DL communication and UL communication are not simultaneously performed, by the terminal, with the base station, and wherein, in a second slot, the DL communication and the UL communication are simultaneously performed with a base station based on the second DL BWP configuration information.

### CROSS-REFERENCE TO RELATED APPLICATIONS

This application is a by-pass continuation application of International Application No. PCT/KR2023/002578, filed on Feb. 23, 2023, which is based on and claims priority to Korean Patent Application Nos. 10-2022-0049649, filed on Apr. 21, 2022, and 10-2022-0056335, filed on May 9, 2022, in the Korean Intellectual Property Office, the disclosures of which are incorporated by reference herein their entireties.

### BACKGROUND

### 1. Field

The disclosure relates to a terminal and an operating method for cross division duplex (XDD) system for bandwidth part (BWP) switching and resource configuration.

### 2. Description of Related Art

To satisfy an increasing demand for wireless data traffic after the commercialization of a fourth-generation (4G) communication system, efforts have been made to develop an improved fifth-generation (5G) communication system or a pre-5G communication system. For this reason, the 5G communication system or the pre-5G communication system is referred to as a beyond 4G network communication system or a post long-term evolution (LTE) system.

To achieve a high data transmission rate, the implementation of the 5G communication system in a super high frequency (mmWave) band (e.g., 60 GHz band) is considered. To mitigate a path loss of radio waves and increase a transmission distance of radio waves in the super high frequency band, beamforming, massive multiple-input multiple-output (MIMO), full dimensional MIMO (FD-MIMO), array antenna, analog beam-forming, and large scale antenna techniques have been discussed and developed for the 5G communication system. In addition, to improve a network of the system, techniques, such as an advanced small cell, an improved small cell, a cloud radio access network (RAN), an ultra-dense network, device-to-device communication (D2D), wireless backhaul, a moving network, cooperative communication, coordinated multi-points (COMP), and interference cancellation, have been developed. Furthermore, in the 5G system, hybrid FSK and QAM modulation (FQMA), which is advanced coding modulation (ACM), sliding window superposition coding (SWSC), filter bank multi-carrier (FBMC), which is an advanced connection technique, non-orthogonal multiple access (NOMA), and sparse code multiple access (SCMA), have been developed.

The Internet has evolved from a human-centric connection network in which a person generates and consumes information to the Internet of Things (IoT) in which information is processed by transmitting and receiving the information among distributed components, such as an object. An Internet of Everything (IoE) technique, which is a combination of an IoT technique with a big data processing technique through the connection with a cloud server has also emerged. To implement the IoT techniques, such as a sensing technique, wired or wireless communication and network infrastructure, a service interface technique, and a security technique, are required, and thereby, a sensor network for the connection between objects, machine to machine (M2M), machine type communication (MTC) techniques have been recently studied. In an IoT environment, an intelligent internet technology (IT) service in which a new value is created to human lives by collecting and analyzing data generated from connected objects may be provided. The IoT may apply to fields, such as a smart home, smart building, smart city, smart car or connected car, smart grid, healthcare, smart home appliance, and cutting-edge medical service, through the fusion and combination of existing IT techniques with various industries.

Accordingly, various attempts have been made to apply the 5G communication system to an IoT network. For example, techniques, such as a sensor network, M2M, and MTC, have been implemented by 5G communication techniques, such as beamforming, MIMO, and array antenna. The application of a cloud RAN as a big data processing technique described above may be an example of the fusion of the 5G and IoT techniques.

To improve coverages of a base station and a terminal, like a time division duplex (TDD) system, uplink (UL) and downlink (DL) resources in a time domain may be divided according to a traffic ratio of a UL and a DL, and UL and DL resources may be divided in a frequency domain like a frequency domain division duplex (FDD) system. As described above, a system that enables flexibly dividing UL resources and DL resources in the time domain and the frequency domain may be referred to as a ‘cross-division duplex (XDD)’ system. Other terms, such as a flexible TDD system, a hybrid TDD system, a TDD-FDD system, and a hybrid TDD-FDD system, are also interchangeably used or referred to as an XDD system in the related art and in the disclosure. In the XDD, X may represent time or frequency.

### SUMMARY

Provided is a cross-division duplex (XDD) system that supports XDD configuration (or XDD resource configuration) in various schemes.

Provided is an XDD system that is able to perform XDD bandwidth part (BWP) switching.

Provided is an XDD system that defines a priority between an uplink (UL) signal/channel and a downlink (DL) signal/channel when a resource overlap between the UL signal/channel and the DL signal/channel occurs.

According to an aspect of the disclosure, a method of a terminal, includes: receiving, from a base station, first downlink (DL) bandwidth part (BWP) configuration information comprising an identifier (ID) of a first DL BWP; receiving, from the base station, first uplink (UL) BWP configuration information comprising an ID of a first UL BWP; receiving, from the base station, second DL BWP configuration information comprising an ID of a second DL BWP and an ID of a second UL BWP; and recognizing, through the ID of the second UL BWP, that the second DL BWP configuration information is information for DL-UL configuration of the terminal, wherein, in a first slot, when the first DL BWP and the first UL BWP are temporally separated from each other, DL communication and UL communication are not simultaneously performed, by the terminal, with the base station, and wherein, in a second slot, the DL communication and the UL communication are simultaneously performed, by the terminal, with the base station based on the second DL BWP configuration information.

According to an aspect of the disclosure, a method of a base station, includes: transmitting first downlink (DL) bandwidth part (BWP) configuration information comprising an identifier (ID) of a first DL BWP to a terminal; transmitting, to the terminal, first uplink (UL) BWP configuration information comprising an ID of a first UL BWP; and transmitting, to the terminal, second DL BWP configuration information comprising an ID of a second DL BWP and an ID of a second UL BWP for DL-UL configuration of the terminal, wherein, in a first slot, when the first DL BWP and the first UL BWP are temporally separated from each other, DL communication and UL communication are not simultaneously performed by the base station with the terminal, and wherein, in a second slot, the DL communication and the UL communication are not simultaneously performed by the base station with the terminal based on the second DL BWP configuration information.

In addition, various effects directly or indirectly ascertained through the disclosure may be provided.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain that is a radio resource domain in which data or a control channel is transmitted in a 5G wireless communication system;

FIG. 2 is a diagram of an example of a slot structure used in a 5G wireless communication system;

FIG. 3 is a diagram of an example of configuration a bandwidth part (BWP) of a 5G wireless communication system;

FIG. 4 is a diagram of an example of a control resource set in which a control channel is transmitted in a 5G wireless communication system;

FIG. 5 is a diagram illustrating a structure of a downlink control channel of a 5G wireless communication system;

FIG. 6 is a diagram of an example of a method of configuration uplink and downlink resources of a 5G wireless communication system;

FIG. 7 is a diagram of an example of an uplink-downlink resource configuration of a cross division duplex (XDD) system according to some embodiments of the disclosure;

FIGS. 8A to 10B are diagrams of examples of time division duplex (TDD)-based XDD configurations according to some embodiments of the disclosure;

FIG. 11 is a diagram illustrating examples of BWP-based XDD configurations according to some embodiments of the disclosure;

FIGS. 12 to 16 are diagrams illustrating BWP switching according to some embodiments of the disclosure;

FIG. 17 is a diagram illustrating a resource overlap according to some embodiments of the disclosure.

FIG. 18 is a flowchart illustrating an operation method of a terminal according to some embodiments of the disclosure;

FIG. 19 is a block diagram illustrating a base station according to some embodiments of the disclosure;

FIG. 20 is a block diagram illustrating a terminal according to some embodiments of the disclosure; and

FIG. 21 is a block diagram of an electronic device in a network environment according to some embodiments of the disclosure.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

Herein, a base station may be an entity performing resource allocation of a terminal and may be at least one of a gNode B, an eNode B, a Node B, a base station (BS), a wireless connection unit, a base station controller, or a node in a network. A terminal may include user equipment (UE), a mobile station (MS), a cellular phone, a smartphone, a computer, or a multimedia system for performing a communication function. Herein, a downlink (DL) may be a wireless transmission path of a signal transmitted from a base station to a terminal and an uplink (UL) may be a wireless transmission path of a signal transmitted from a terminal to a base station. In addition, herein, long-term evolution (LTE), LTE-advanced (LTE-A), or a fifth-generation (5G) system may be provided as an example, but embodiments of the disclosure may apply to other communication systems having similar technical backgrounds or channel types. For example, the 5G mobile communication technology (new radio (NR)) developed after LTE-A may be included therein and the 5G described hereinafter may be a concept including LTE, LTE-A, and other similar services. In addition, the disclosure may apply to other communication systems through partial modification without significantly departing from the scope of the disclosure based on the determination of a skilled person with technical knowledge.

The wireless communication system may depart from providing an early voice-oriented service and for example, may evolve into a wide-band wireless communication system that provides a high-speed and high-quality packet data service, such as high-speed packet access (HSPA) of 3GPP, LTE (LTE or evolved-universal terrestrial radio access (E-UTRA)), LTE-A, LTE-Pro, high rate packet data (HRPD) of 3GPP2, ultra-mobile broadband (UMB), and communication standards, such as IEEE 802.16e.

As a representative example of the wide-band wireless communication system, an LTE system may adopt orthogonal frequency division multiplexing (OFDM) in a DL and single carrier-frequency division multiple access (SC-FDMA) in a UL. The UL may refer to a wireless link for transmitting data or a control signal from a mobile station (MS) to a base station (an eNode B or a BS), and the DL may refer to a wireless link for transmitting data or a control signal from a base station to a terminal. The multiple access scheme described above may distinguish data or control information of each user by allocating and operating time-frequency resources to prevent an overlap of the time-frequency resources to carry data or control information for each user, in other words, to establish orthogonality.

Since a future communication system after LTE, in other words, the 5G communication system needs to freely reflect various requirements of a user and a service provider, a service that simultaneously satisfies various requirements may need to be supported. A service considered for the 5G communication system may be enhanced mobile broadband (eMBB), massive machine type communication (mMTC), and ultra-reliability low latency communication (URLLC).

The eMBB may aim to provide more enhanced data transmission speed than the data transmission speed supported by the existing LTE, LTE-A, or LTE-Pro. For example, in the 5G communication system, eMBB may need to provide 20 Gbps of the maximum transmission speed (peak data rate) in the DL and 10 Gbps of the maximum transmission speed in the UL in an aspect of a base station. In addition, the 5G communication system may need to provide an increased user-perceived data rate of a terminal while providing the peak data rate. To satisfy the requirement described above, improvements in various transmission and reception techniques including more enhanced multiple-input multiple-output (MIMO) may be required. In addition, the 5G communication system may satisfy the data transmission speed required by the 5G communication system by using a frequency bandwidth wider than 20 MHz in a frequency band of 3 to 6 GHz or above 6 GHz whereas LTE transmits a signal using the transmission bandwidth up to 20 MHz in a 2 GHz band.

Simultaneously, in the 5G communication system, mMTC may be considered to support an application service, such as the Internet of Things (IoT). mMTC may require a large scale of terminal connection support in a cell, enhanced coverage of a terminal, enhanced battery time, and cost reduction of the terminal to efficiently provide IoT. Since the IoT is attached to various sensors and devices and provides a communication function, a large number of terminals (e.g., 1,000,000 terminals/km2) may need to be supported in a cell. In addition, since a terminal supporting mMTC is likely to be located in a shaded area that a cell is not able to cover, such as the basement of a building, the terminal may require wider coverage than other services provided by the 5G communication system. The terminal supporting mMTC may need to consist of a low-cost terminal, and since it is difficult to frequently change a battery of the terminal, a significantly long battery lifetime, such as 10 to 15 years, may be required.

URLLC may be a cellular-based wireless communication service used for a specific purpose (mission-critical). For example, a service used for remote control of a robot or machinery, industrial automation, an unmanned aerial vehicle, remote health care, and an emergency alert may be considered. Accordingly, the communication provided by URLLC may need to provide significantly low latency and significantly high reliability. For example, the service supporting URLLC may need to satisfy air interface latency smaller than 0.5 milliseconds and a packet error rate less than or equal to 75. Accordingly, for the service supporting URLLC, the 5G system may need to provide a transmit time interval (TTI) that is smaller than other services and may require a design matter to allocate a wide resource in a frequency band to secure the reliability of a communication link.

The three services of 5G, which are eMBB, URLLC, and mMTC, may be multiplexed in a single system and may be transmitted. In this case, different transmission and reception methods and transmission and reception parameters may be used between services to satisfy different requirements of each service. The 5G is not limited to the three services described above.

Hereinafter, a frame structure of the 5G system is further described with reference to drawings.

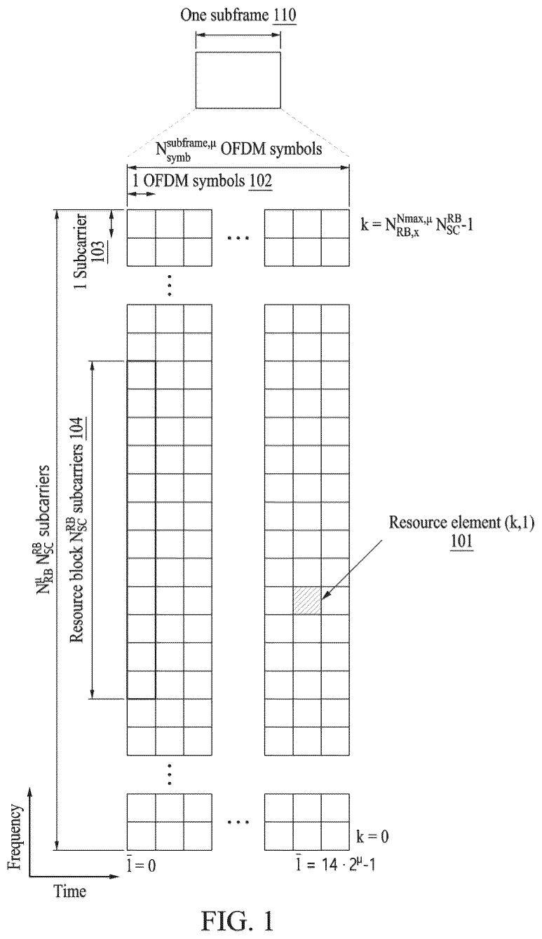

FIG. 1 is a diagram illustrating a basic structure of a time-frequency domain that is a radio resource domain in which data or a control channel is transmitted in a 5G wireless communication system.

Referring to FIG. 1, a horizontal axis may represent a time domain and a vertical axis may represent a frequency domain. A basic unit of a resource in time and frequency domains may be a resource element (RE) 101 and may be defined as 1 OFDM symbol 102 on a time axis and 1 subcarrier 103 on a frequency axis. In the frequency domain, NRB sc (e.g., 12) consecutive REs may constitute one resource block (RB) 104.

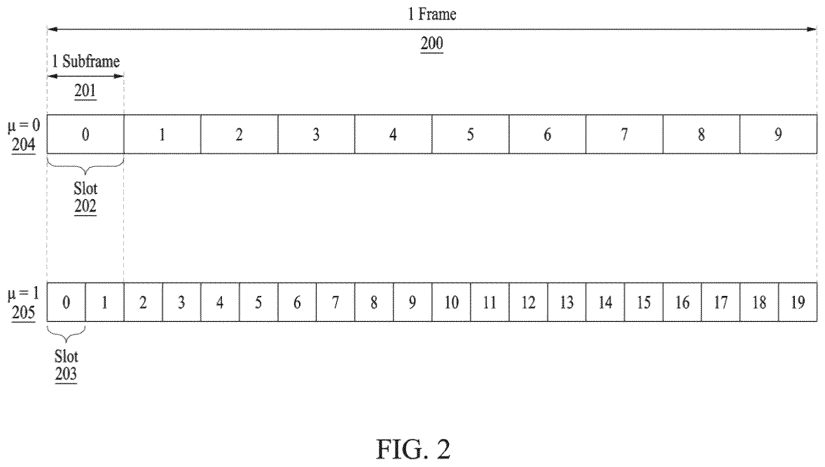

FIG. 2 is a diagram of an example of a slot structure used in a 5G wireless communication system.

Referring to FIG. 2, an example of a structure including a frame 200, a subframe 201, and a slot 202 is illustrated. The 1 frame 200 may be defined as 10 ms. The 1 subframe 201 may be defined as 1 ms and therefore, the 1 frame 200 may include a total of 10 subframes 201. One slot 202 and 203 may be defined as 14 OFDM symbols (in other words, the number of symbols N_{symb}^{slot} per slot is 14). The 1 subframe 201 may include one or a plurality of slots 202 and 203, and the number of slots 202 and 203 per subframe 201 may vary depending on configuration values μ 204 and 205 with respect to a subcarrier interval. In an example of FIG. 2, for the subcarrier interval configuration value, a case 204 in which μ=0 and a case 205 in which μ=1 are illustrated. In the case 204 in which μ=0, the 1 subframe 201 may consist of one slot 202, and in the case 205 in which μ=1, the 1 subframe 201 may consist of two slots 203. In other words, the number of slots Nₛₗₒₜ^{subframe,μ} slot per subframe may vary depending on the configuration value u with respect to the subcarrier interval and accordingly, the number of slots Nₛₗₒₜ^{frame,μ} per frame may vary. Nₛₗₒₜ^{subframe,μ} and Nₛₗₒₜ^{frame,μ} slot depending on each subcarrier interval configuration u may be defined by Table 1 shown below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Next, a bandwidth part (BWP) configuration in a 5G communication system is further described with reference to drawings.

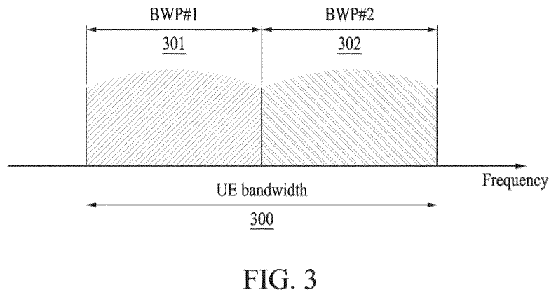

FIG. 3 is a diagram of an example of configuration a bandwidth part (BWP) of a 5G wireless communication system.

Referring to FIG. 3, an example in which a terminal (UE) bandwidth 300 is configured into two BWPs, in other words, a BWP #1 301 and a BWP #2 302 is illustrated. A base station may configure one or a plurality of BWPs to a terminal and may configure information of Table 2 shown below to each BWP.

TABLE 2

| BWP ::= | SEQUENCE { |
|---|---|
| bwp-Id | BWP-Id, |
| locationAndBandwidth | INTEGER (1..65536), |
| subcarrierSpacing | ENUMERATED {n0, n1, n2, n3, n4, |
| n5}, | |
| cyclicPrefix | ENUMERATED { extended } |

}

Configuration of the BWP is not limited to the example described above and various parameters related to the BWP other than the configuration information may be configured to the terminal. The configuration information may be transmitted by the base station to the terminal through higher layer signaling, for example, radio resource control (RRC) signaling. At least one BWP of the one or the plurality of configured BWPs may be activated. An activation status of the configured BWP may be semi-statically transmitted to the terminal from the base station through RRC signaling or may be dynamically transmitted through downlink control information (DCI).

According to an embodiment, for a terminal before RRC connection, an initial BWP for initial connection may be configured by the base station through a master information block (MIB). Specifically, the terminal may receive configuration information on a search space and a control resource set (CORESET) in which PDCCH for the reception of system information (may correspond to remaining system information (RMSI) or a system information block 1 (SIB 1)) required for the initial connection is transmitted through the MIB in an initial connection stage. The control resource set that is configured by the MIB may be regarded as an identifier (ID) (identity) 0. The base station may notify the terminal configuration information such as time allocation information, frequency allocation information, and numerology, etc., for a control resource set #0 through the MIB. In addition, the base station may notify the terminal of configuration information on a monitoring period and occasion for the control resource set #0, in other words, configuration information on a search space #0, through the MIB. The terminal may regard a frequency domain configured as the control resource set #0 obtained from the MIB as an initial BWP for the initial connection. In this case, the ID of the initial BWP may be regarded as 0.

The configuration of the BWP supported by the 5G wireless communication system may be used for various purposes.

According to an embodiment, when the system bandwidth is smaller than the bandwidth supported by the terminal, the configuration with respect to the BWP may be used. For example, the terminal may transmit or receive data at a specific frequency location in the system bandwidth as the base station configures the terminal with a frequency location (configuration information 2) of the BWP.

In addition, according to an embodiment, the base station may configure a plurality of BWPs to the terminal to support different numerologies. For example, the base station may configure two BWPs to subcarrier intervals of 15 kHz and 30 kHz, respectively, to support both data transmission and reception using the subcarrier interval of 15 kHz and the subcarrier interval of 30 kHz to a terminal. The different BWPs may be frequency division multiplexed and when the base station attempts to transmit or receive data at a specific subcarrier interval, the BWP configured to the subcarrier interval may be activated.

In addition, according to an embodiment, the base station may configure a BWP having different sizes of bandwidths to the terminal to reduce power consumption of the terminal. For example, when the terminal supports a significantly great bandwidth, for example, a bandwidth of 100 MHz and always transmits or receives data with the bandwidth, power may be significantly consumed. Specifically, performing monitoring on an unnecessary DL control channel with the great bandwidth of 100 MHz while there is no traffic, may be significantly inefficient in an aspect of power consumption. The base station may configure a BWP of a relatively small bandwidth, for example, a BWP of 20 MHz, to the terminal to reduce the power consumption of the terminal. The terminal may perform a monitoring operation in the 20 MHz BWP while there is no traffic and when data occurs, the terminal may transmit or receive data with the 100 MHz BWP according to the instruction of the base station.

In a method of configuring the BWP, terminals before the RRC connection may receive configuration information on an initial BWP through an MIB in an initial connection stage. Specifically, a control resource set for a DL control channel in which DCI that schedules a system information block (SIB) from an MIB of a physical broadcast channel (PBCH) may be configured to the terminal. The bandwidth of the control resource set that is configured to MIB may be regarded as an initial BWP and the terminal may receive a physical downlink shared channel (PDSCH) in which an SIB is transmitted through the configured initial BWP. The initial BWP may be utilized for other system information (OSI), paging, and random access other than receiving an SIB.

If one or more BWPs are configured to the terminal, the base station may instruct the terminal to change the BWP using a BWP indicator field in the DCI. As an example, when a currently activated BWP of the terminal of FIG. 3 is a BWP #1 301, the base station may indicate a BWP #2 302 as a BWP indicator in the DCI to the terminal and the terminal may change the BWP to the BWP #2 302 indicated as the BWP indicator in the received DCI.

As described above, since a change in a BWP based on DCI may be instructed by the DCI that schedules a PDSCH or a PUSCH, when the terminal receives a request for changing the BWP, the terminal may need to receive or transmit the PDSCH or PUSCH scheduled by the DCI in a changed BWP without a problem. For this, the standard may specify a requirement for latency T_{BWP} required when changing a BWP and may be defined as, for example, Table 3 shown below.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | [1] | [3] |
| 1 | 0.5 | [2] | [5] |
| 2 | 0.25 | [3] | [9] |
| 3 | 0.125 | [6] | [17] |

^{Note 1}
Depends on UE capability.
Note 2:
If the BWP switch involves changing of SCS, the BWP switch delay is determined by the larger one between the SCS before BWP switch and the SCS after BWP switch.

The requirement for BWP change latency may support type 1 or type 2 depending on the capability of the terminal. The terminal may report a supportable BWP latency type to the base station.

According to the requirement for the BWP change latency described above, when the terminal receives DCI including a BWP change indicator in a slot n, the terminal may complete a change to a new BWP indicated by the BWP change indicator at a time point no later than n+T_{BWP}, and may transmit or receive a data channel scheduled by the DCI in the new changed BWP. When the base station attempts to schedule a data channel to the new BWP, the base station may determine time domain resource allocation to the data channel by considering the BWP change latency T_{BWP}. In other words, when the base station schedules a data channel to the new BWP, in a method of determining a time domain resource allocation to a data channel, the base station may schedule the data channel after BWP change latency. Accordingly, the terminal may not expect that the DCI indicating the BWP change indicates a slot offset value (K0 or K2) that is less than the BWP change latency T_{BWP}.

If the terminal receives DCI (e.g., DCI format 1_1 or 0_1) indicating the BWP change, the terminal may not perform any transmission or reception during a time interval from a third symbol of a slot that receives a PDCCH including the DCI to a start point of a slot indicated by a slot offset (K0 or K2) indicated in a time domain resource allocation indicator field in the DCI. For example, when the terminal receives DCI indicating a BWP change in a slot n and a slot offset value indicated by the DCI is K, the terminal may not perform any transmission or reception from a third symbol of the slot n to a symbol previous to a slot n+K (in other words, a last symbol of a slot n+K−1).

Next, a synchronization signal (SS)/PBCH block in a 5G wireless communication system is described.

A SS/PBCH block may be a physical layer channel block including a primary SS (PSS), a secondary SS (SSS), and a PBCH. A detailed description thereof is as follows.
PSS: a signal serving as a standard for DL time/frequency synchronization and providing partial information of a cell ID.
SSS: a signal serving as a standard for DL time/frequency synchronization and providing remaining cell ID information that is not provided by the PSS In addition, it may function as a reference signal for demodulation of a PBCH.
PBCH: provides essential system information required for transmitting and receiving a data channel and a control channel of a terminal. The essential system information may include control information related to a search space showing wireless resource mapping information of a control channel, and scheduling control information on a separate data channel that transmits the system information.
SS/PBCH block: The SS/PBCH block consists of a combination of a PSS, an SSS, and a PBCH. One or a plurality of SS/PBCH blocks may be transmitted in 5 ms and each transmitted SS/PBCH block may be distinguished by an index.

The terminal may detect a PSS and an SSS in an initial connection stage and may decode a PBCH. The MIB may be obtained from the PBCH and a control resource set (CORESET) #0 (may correspond to a control resource set of which a control resource set index is 0) may be configured therefrom. The terminal may assume that the selected SS/PBCH block and a demodulation reference signal (DMRS) transmitted by the control resource set #0 are quasi-colocated (QCLed) and may perform monitoring on the control resource set #0. The terminal may receive the system information as the DL control information transmitted by the control resource set #0. The terminal may obtain configuration information related to a random access channel (RACH) required for initial connection from the received system information. The terminal may transmit a physical RACH (PRACH) to the base station by considering the selected SS/PBCH index, and the base station receiving the PRACH may obtain information on the SS/PBCH block index selected by the terminal. The base station may know which block the terminal has selected from SS/PBCH blocks and whether the control resource set #0 related thereto is monitored.

Next, the DCI in a 5G wireless communication system is further described.

In the 5G system, scheduling information on UL data (or a physical uplink shared channel (PUSCH)) or DL data (or a physical downlink shared channel (PDSCH)) may be transmitted from a base station to a terminal through the DCI. The terminal may monitor a DCI format for fallback and a DCI format for non-fallback for the PUSCH or the PDSCH. The fallback DCI format may include a predefined fixed field between the base station and the terminal and the non-fallback DCI format may include a configurable field.

The DCI may be transmitted via a physical downlink control channel (PDCCH), through channel coding and modulation processes. A cyclic redundancy check (CRC) may be attached to a DCI message payload and the CRC may be scrambled by a radio network temporary identifier (RNTI) corresponding to the identity of the terminal. Depending on the purpose of a DCI message, for example, UE-specific data transmission, a power control command, or a random access response, different RNTIs may be used. In other words, the RNTI may not be explicitly transmitted and may be transmitted by being included in a CRC calculation process. When the terminal receives the DCI message transmitted through the PDCCH, the terminal may check the CRC using the allocated RNTI and if a CRC check result is correct, the terminal may know that the message is transmitted to the terminal.

For example, the DCI that schedules the PDSCH for the system information (SI) may be scrambled by an SI-RNTI. DCI that schedules a PDSCH for a random access response (RAR) message may be scrambled by a random access (RA)-RNTI. DCI that schedules a PDSCH for a paging message may be scrambled by a P-RNTI. DCI that notifies a slot format indicator (SFI) may be scrambled by an SFI-RNTI. DCI that notifies transmit power control (TPC) may be scrambled by a TPC-RNTI. DCI that schedules a UE-specific PDSCH or PUSCH may be scrambled by a cell-RNTI (C-RNTI), modulation coding scheme C-RNTI (MCS-C-RNTI), or a configured scheduling RNTI (CS-RNTI).

The DCI format 0_0 may be used as fallback DCI that schedules a PUSCH and in this case, the CRC may be scrambled by the C-RNTI. The DCI format 0_0 in which the CRC is scrambled by the C-RNTI may include, for example, the information shown in Table 4 below.

TABLE 4

| | |
|---|---|
| - | Identifier for DCI formats (DCI format ID) - 1 bit |
| - | The value of this bit field is always set to 0, indicating an UL DCI format |
| - | Frequency domain resource assignment - ┌log₂(N [symbol] (N [symbol] + 1)/2┐ bits where |

N [symbol] is defined in Subclause 7.3.1.0

| | |
|---|---|
| - | For PUSCH hopping with resource allocation type 1: |
| - | N_{UL}_{_{—}} [symbol] most significant bit (MSB) bits are used to indicate the frequency offset |

according to Subclause 6.3 of [6, TS 38.214], where N_{UL}_{_{—}} [symbol] = 1 if the higher layer parameter
frequencyHoppingOffsetLists contains two offset values and N_{UL}_{_{—}} [symbol] = 2 if the higher layer
parameter frequencyHoppingOffsetLists contains four offset values

| | |
|---|---|
| - | ┌log₂(N [symbol] (N [symbol] + 1)/2┐ − N_{UL}_{_{—}} [symbol] bits provides the frequency domain resource |

allocation according to Subclause 6.1.2.2.2 of [6, TS 38.214]

| | |
|---|---|
| - | For non-PUSCH hopping with resource allocation type 1: |
| - | ┌log₂(N [symbol] (N [symbol] + 1)/2┐ bits provides the frequency domain resource |

allocation according to Subclause 6.1.2.2.2 of [6, TS 38.214]

| | |
|---|---|
| - | Time domain resource assignment - 4 bits as defined in Subclause 6.1.2.1 of [6, TS |

38.214]

| | |
|---|---|
| - | Frequency hopping flag - 1 bit according to Table 7.3.1.1.1-3, as defined in Subclause |

6.3 of [6, TS 38.214]

| | |
|---|---|
| - | Modulation and coding scheme - 5 bits as defined in Subclause 6.1.4.1 of [6, TS |

38.214]

| | |
|---|---|
| - | New data indicator - 1 bit |
| - | Redundancy version - 2 bits as defined in Table 7.3.1.1.1-2 |
| - | Hybrid automatic repeat-request (HARQ) process number - 4 bits |
| - | TPC command for scheduled PUSCH - 2 bits as defined in Subclause 7.1.1 of [5, TS |

38.213]

| | |
|---|---|
| - | Padding bits, if required. |
| - | UL/supplementary UL (SUL) indicator - 1 bit for UEs configured with |

supplementaryUplink in ServingCellConfig in the cell as defined in Table 7.3.1.1.1-1 and the
number of bits for DCI format 1_0 before padding is larger than the number of bits for DCI
format 0_0 before padding; 0 bit otherwise. The UL/SUL indicator, if present, locates in the
last bit position of DCI format 0_0, after the padding bit(s).

| | |
|---|---|
| - | If the UL/SUL indicator is present in DCI format 0_0 and the higher layer parameter |

pusch-Config is not configured on both UL and SUL the UE ignores the UL/SUL indicator
field in DCI format 0_0, and the corresponding PUSCH scheduled by the DCI format 0_0 is
for the UL or SUL for which high layer parameter pucch-Config is configured;

| | |
|---|---|
| - | If the UL/SUL indicator is not present in DCI format 0_0 and pucch-Config is |

configured, the corresponding PUSCH scheduled by the DCI format 0_0 is for the UL or SUL
for which high layer parameter pucch-Config is configured.

| | |
|---|---|
| - | If the UL/SUL indicator is not present in DCI format 0_0 and pucch-Config is not |

configured, the corresponding PUSCH scheduled by the DCI format 0_0 is for the uplink on
which the latest PRACH is transmitted. [symbol]
indicates data missing or illegible when filed

The DCI format 0_1 may be used as non-fallback DCI that schedules a PUSCH and in this case, the CRC may be scrambled by the C-RNTI. The DCI format 0_1 in which the CRC is scrambled by the C-RNTI may include, for example, the information shown in Table 5 below.

TABLE 5
- Identifier for DCI formats (DCI format ID) - 1 bit
- The value of this bit field is always set to 0, indicating an UL DCI format
- Carrier indicator - 0 or 3 bits, as defined in Subclause 10.1 of [5, TS38.213].
- UL/SUL indicator - 0 bit for UEs not configured with supplementaryUplink in
ServingCellConfig in the cell or UEs configured with supplementaryUplink in ServingCellConfig
in the cell but only PUCCH carrier in the cell is configured for PUSCH transmission; otherwise,
1 bit as defined in Table 7.3.1.1.1-1.
- Bandwidth part indicator - 0, 1 or 2 bits as determined by the number of UL BWPs n [symbol]
configured by higher layers, excluding the initial UL bandwidth part. The bitwidth for this field
is determined as ┌log₂(n [symbol] )┐ bits, where
- n_{BWP} = n_{BWP ·RRC} + 1 if n_{BWP ·RRC} ≤ 3, in which case the bandwidth part indicator is equivalent
to the ascending order of the higher layer parameter BWP-Id;
- otherwise n_{BWP} = n [symbol] , in which case the bandwidth part indicator is defined in Table
7.3.1.1.2-1;
If a UE does not support active BWP change via DCI, the UE ignores this bit field.
- Frequency domain resource assignment - number of bits determined by the following,
where n [symbol] is the size of the active UL bandwidth part:
- N [symbol] bits if only resource allocation type 0 is configured, where N [symbol] is defined in
Subclause 6.1.2.2.1 of [6, TS 38.214],
- ┌log₂(N [symbol] (N [symbol] + 1)/2)┐ bits if only resource allocation type 1 is configured, or
max(┌log₂(N [symbol] (N [symbol] + 1)/2)┐, N [symbol] ) + 1 bits if both resource allocation type 0 and 1 are configured.
- If both resource allocation type 0 and 1 are configured, the MSB bit is used to indicate
resource allocation type 0 or resource allocation type 1, where the bit value of 0 indicates resource
allocation type 0 and the bit value of 1 indicates resource allocation type 1.
- For resource allocation type 0, the N [symbol] LSBs provide the resource allocation as defined
in Subclause 6.1.2.2.1 of [6, TS 38.214].
- For resource allocation type 1, the ┌log₂ (N [symbol] (N [symbol] + 1)/2)┐ LSBs provide the
resource allocation as follows:
- For PUSCH hopping with resource allocation type 1:
- N [symbol] MSB bits are used to indicate the frequency offset according to Subclause 6.3 of
[6, TS 38.214], where N [symbol] = 1 if the higher layer parameter frequencyHoppingOffsetLists
contains two offset values and N [symbol] = 2 if the higher layer parameter
frequencyHoppingOffsetLists contains four offset values
- ┌log₂(N [symbol] (N [symbol] + 1)/2)┐- N [symbol] bits provides the frequency domain resource
allocation according to Subclause 6.1.2.2.2 of [6, TS 38.214]
- For non-PUSCH hopping with resource allocation type 1:
- ┌log₂(N [symbol] (N [symbol] + 1)/2)┐ bits provides the frequency domain resource allocation
according to Subclause 6.1.2.2.2 of [6, TS 38.214]
If “Bandwidth part indicator” field indicates a bandwidth part other than the active bandwidth
part and if both resource allocation type 0 and 1 are configured for the indicated bandwidth part,
the UE assumes resource allocation type 0 for the indicated bandwidth part if the bitwidth of the
“Frequency domain resource assignment” field of the active bandwidth part is smaller than the
bitwidth of the “Frequency domain resource assignment” field of the indicated bandwidth part.
- Time domain resource assignment - 0, 1, 2, 3, or 4 bits as defined in Subclause 6.1.2.1 of
[6, TS38.214]. The bitwidth for this field is determined as ┌log₂(I)┐ bits, where I is the number
of entries in the higher layer parameter pusch-TimeDomainAllocationList if the higher layer
parameter is configured; otherwise I is the number of entries in the default table.- Frequency
hopping flag - 0 or 1 bit:
- 0 bit if only resource allocation type 0 is configured or if the higher layer parameter
frequencyHopping is not configured;
- 1 bit according to Table 7.3.1.1.1-3 otherwise, only applicable to resource allocation type
1, as defined in Subclause 6.3 of [6, TS 38.214].
- Modulation and coding scheme - 5 bits as defined in Subclause 6.1.4.1 of [6, TS 38.214]
- New data indicator - 1 bit
- Redundancy version - 2 bits as defined in Table 7.3.1.1.1-2
- HARQ process number - 4 bits
- 1^{st} downlink assignment index - 1 or 2 bits:
- 1 bit for semi-static HARQ-ACK codebook;
- 2 bits for dynamic HARQ-ACK codebook.
- 2^{nd} downlink assignment index - 0 or 2 bits:
- 2 bits for dynamic HARQ-ACK codebook with two HARQ-ACK sub-codebooks;
- 0 bit otherwise.
- TPC command for scheduled PUSCH - 2 bits as defined in Subclause 7.1.1 of [5, TS38.213]
- Sounding reference signal (SRS) resource indicator - $⌈ {log}_{2} ( {\sum }_{k = 1}^{min ( {L}_{max} , {N}_{SRS} )} ( \begin{matrix}{N}_{SRS} \\ k\end{matrix} ) ) ⌉ oR$
┌log₂(N_{SRS})┐ bits, where N_{SRS} is the number of configured SRS resources in the SRS resource set
associated with the higher layer parameter usage of value ‘codeBook’ or ‘nonCodeBook’,
- $⌈ {log}_{2} ( {\sum }_{k = 1}^{min ( {L}_{max} , {N}_{SRS} )} ( \begin{matrix}{N}_{SRS} \\ k\end{matrix} ) ) ⌉ bits according to Tables 7.3 \text{.1} \text{.1} \text{.228} / 29 / 30 / 31 if the higher layer$
parameter txConfig = nonCodebook, where N_{SRS} is the number of configured SRS resources in
the SRS resource set associated with the higher layer parameter usage of value ‘nonCodeBook’
and
- if UE supports operation with maxMIMO-Layers and the higher layer parameter
maxMIMO-Layers of PUSCH-ServingCellConfig of the serving cell is configured, Lₘₐₓ is given
by that parameter
- otherwise, Lₘₐₓ is given by the maximum number of layers for PUSCH supported by the
UE for the serving cell for non-codebook based operation.
- ┌log₂(N_{SRS})┐bits according to Tables 7.3.1.1.2-32 if the higher layer parameter txConfig =
codebook, where N_{SRS} is the number of configured SRS resources in the SRS resource set
associated with the higher layer parameter usage of value ‘codeBook’.
- Precoding information and number of layers - number of bits determined by the
following:- 0 bits if the higher layer parameter txConfig = nonCodeBook;
- 0 bits for 1 antenna port and if the higher layer parameter txConfig = codebook;
- 4, 5, or 6 bits according to Table 7.3.1.1.2-2 for 4 antenna ports, if txConfig = codebook,
and according to whether transform precoder is enabled or disabled, and the values of higher
layer parameters maxRank, and codebookSubset;
- 2, 4, or 5 bits according to Table 7.3.1.1.2-3 for 4 antenna ports, if txConfig = codebook,
and according to whether transform precoder is enabled or disabled, and the values of higher
layer parameters maxRank, and codebookSubset,
- 2 or 4 bits according to Table7.3.1.1.2-4 for 2 antenna ports, if txConfig = codebook, and
according to whether transform precoder is enabled or disabled, and the values of higher layer
parameters maxRank and codebookSubset;
- 1 or 3 bits according to Table7.3.1.1.2-5 for 2 antenna ports, if txConfig = codebook, and
according to whether transform precoder is enabled or disabled, and the values of higher layer
parameters maxRank and codebookSubset.
- Antenna ports - number of bits determined by the following- 2 bits as defined by
Tables 7.3.1.1.2-6, if transform precoder is enabled, dmrs-Type=1, and maxLength=1;
- 4 bits as defined by Tables 7.3.1.1.2-7, if transform precoder is enabled, dmrs-Type=1,
and maxLength=2;
- 3 bits as defined by Tables 7.3.1.1.2-8/9/10/11, if transform precoder is disabled, dmrs-
Type=1, and maxLength=1, and the value of rank is determined according to the SRS resource
indicator field if the higher layer parameter txConfig = nonCodebook and according to the
Precoding information and number of layers field if the higher layer parameter txConfig =
codebook;
- 4 bits as defined by Tables 7.3.1.1.2-12/13/14/15, if transform precoder is disabled, dmrs-
Type=1, and maxLength=2, and the value of rank is determined according to the SRS resource
indicator field if the higher layer parameter txConfig = nonCodebook and according to the
Precoding information and number of layers field if the higher layer parameter txConfig =
codebook;
- 4 bits as defined by Tables 7.3.1.1.2-16/17/18/19, if transform precoder is disabled, dmrs-
Type=2, and maxLength=1, and the value of rank is determined according to the SRS resource
indicator field if the higher layer parameter txConfig = nonCodebook and according to the
Precoding information and number of layers field if the higher layer parameter txConfig =
codebook;
- 5 bits as defined by Tables 7.3.1.1.2-20/21/22/23, if transform precoder is disabled, dmrs-
Type=2, and maxLength=2, and the value of rank is determined according to the SRS resource
indicator field if the higher layer parameter txConfig = nonCodebook and according to the
Precoding information and number of layers field if the higher layer parameter txConfig =
codebook.
where the number of CDM groups without data of values 1, 2, and 3 in Tables 7.3.1.1.2-6 to
7.3.1.1.2-23 refers to CDM groups {0}, {0, 1}, and {0, 1, 2} respectively.
If a UE is configured with both dmrs-UplinkForPUSCH-MappingTypeA and dmrs-
UplinkForPUSCH-Mapping TypeB, the bitwidth of this field equals max{x_{A}, x_{B}}, where x_{A} is the
“Antenna ports” bitwidth derived according to dmrs-UplinkForPUSCH-MappingTypeA and x_{B}
is the “Antenna ports” bitwidth derived according to dmrs-UplinkForPUSCH-MappingTypeB. A
number of |x_{A} - x_{B}| zeros are padded in the MSB of this field, if the mapping type of the PUSCH
corresponds to the smaller value of x_{A} and x_{B}.
- SRS request - 2 bits as defined by Table 7.3.1.1.2-24 for UEs not configured with
supplementaryUplink in ServingCellConfig in the cell; 3 bits for UEs configured with
supplementaryUplink in ServingCellConfig in the cell where the first bit is the non-SUL/SUL
indicator as defined in Table 7.3.1.1.1-1 and the second and third bits are defined by Table
7.3.1.1.2-24. This bit field may also indicate the associated CSI-RS according to Subclause
6.1.1.2 of [6, TS 38.214].
- Channel state information (CSI) request - 0, 1, 2, 3, 4, 5, or 6 bits determined by higher
layer parameter reportTriggerSize.
- Cold block group (CBG) transmission information (CBGTI) - 0 bit if higher layer
parameter codeBlockGroupTransmission for PDSCH is not configured, otherwise, 2, 4, 6, or 8
bits determined by higher layer parameter maxCodeBlockGroupsPerTransportBlock for PUSCH.
- Phase tracking reference signal (PTRS)-demodulation reference signal (DMRS)
association - number of bits determined as follows
- 0 bit if PTRS-UplinkConfig is not configured and transform precoder is disabled, or if
transform precoder is enabled, or if maxRank=1;
- 2 bits otherwise, where Table 7.3.1.1.2-25 and 7.3.1.1.2-26 are used to indicate the
association between PTRS port(s) and DMRS port(s) for transmission of one PT-RS port and
two PT-RS ports respectively, and the DMRS ports are indicated by the Antenna ports field.
If “Bandwidth part indicator” field indicates a bandwidth part other than the active bandwidth
part and the “PTRS-DMRS association” field is present for the indicated bandwidth part but not
present for the active bandwidth part, the UE assumes the “PTRS-DMRS association” field is
not present for the indicated bandwidth part.
- beta_offset indicator - 0 if the higher layer parameter betaOffsets = semiStatic; otherwise
2 bits as defined by Table 9.3-3 in [5, TS 38.213].
- DMRS sequence initialization - 0 bit if transform precoder is enabled; 1 bit if transform
precoder is disabled.
- UL-SCH indicator - 1 bit. A value of “1” indicates UL-SCH shall be transmitted on the
PUSCH and a value of “0” indicates UL-SCH shall not be transmitted on the PUSCH. Except
for DCI format 0_1 with CRC scrambled by SP-CSI-RNTI, a UE is not expected to receive a
DCI format 0_1 with UL-SCH indicator of “0” and CSI request of all zero(s). [symbol]
indicates data missing or illegible when filed

The DCI format 1_0 may be used as fallback DCI that schedules a PDSCH and in this case, the CRC may be scrambled by the C-RNTI. The DCI format 1_0 in which the CRC is scrambled by the C-RNTI may include, for example, the information shown in Table 6 below.

TABLE 6

| | |
|---|---|
| - | Identifier for DCI formats - 1 bits |
| - | The value of this bit field is always set to 1, indicating a DL DCI format |
| - | Frequency domain resource assignment - ┌log₂(N [symbol] (N [symbol] + 1)/2┐ bits where |
| N [symbol] | is given by subclause 7.3.1.0 |

If the CRC of the DCI format 1_0 is scrambled by C-RNTI and the “Frequency domain
resource assignment” field are of all ones, the DCI format 1_0 is for random access procedure
initiated by a PDCCH order, with all remaining fields set as follows:

| | |
|---|---|
| - | Random Access Preamble index - 6 bits according to ra-PreambleIndex in Subclause |

5.1.2 of [8, TS38.321]

| | |
|---|---|
| - | UL/supplementary UL (SUL) indicator - 1 bit. If the value of the “Random Access |

Preamble index” is not all zeros and if the UE is configured with supplementaryUplink in
ServingCellConfig in the cell, this field indicates which UL carrier in the cell to transmit the
PRACH according to Table 7.3.1.1.1-1; otherwise, this field is reserved

| | |
|---|---|
| - | SS/PBCH index - 6 bits. If the value of the “Random Access Preamble index” is not all |

zeros, this field indicates the SS/PBCH that shall be used to determine the RACH occasion for
the PRACH transmission; otherwise, this field is reserved.

| | |
|---|---|
| - | PRACH Mask index - 4 bits. If the value of the “Random Access Preamble index” is |

not all zeros, this field indicates the RACH occasion associated with the SS/PBCH indicated
by “SS/PBCH index” for the PRACH transmission, according to Subclause 5.1.1 of [8,
TS38.321]; otherwise, this field is reserved

| | |
|---|---|
| - | Reserved bits - 10 bits |

Otherwise, all remaining fields are set as follows:

| | |
|---|---|
| - | Time domain resource assignment - 4 bits as defined in Subclause 5.1.2.1 of [6, TS |

38.214]

| | |
|---|---|
| - | VRB-to-PRB mapping (virtual resource block-to-physical resource block mapping) - |

1 bit according to Table 7.3.1.2.2-5

| | |
|---|---|
| - | Modulation and coding scheme - 5 bits as defined in Subclause 5.1.3 of [6, TS 38.214] |
| - | New data indicator - 1 bit |
| - | Redundancy version - 2 bits as defined in Table 7.3.1.1.1-2 |
| - | HARQ process number - 4 bits |
| - | Downlink assignment index - 2 bits as defined in Subclause 9.1.3 of [5, TS 38.213], as |

counter DAI

| | |
|---|---|
| - | TPC command for scheduled PUCCH - 2 bits as defined in Subclause 7.2.1 of [5, TS |

38.213]

| | |
|---|---|
| - | PUCCH resource indicator - 3 bits as defined in Subclause 9.2.3 of [5, TS 38.213] |
| - | PDSCH-to-HARQ_feedback timing indicator - 3 bits as defined in Subclause 9.2.3 of |

[5, TS38.213] [symbol]
indicates data missing or illegible when filed

The DCI format 1_1 may be used as non-fallback DCI that schedules a PDSCH and in this case, the CRC may be scrambled by the C-RNTI. The DCI format 1_1 in which the CRC is scrambled by the C-RNTI may include, for example, the information shown in Table 7 below.

TABLE 7

| | |
|---|---|
| | Identifier for DCI formats - 1 bits |
| - | The value of this bit field is always set to 1, indicating a DL DCI format |
| - | Carrier indicator - 0 or 3 bits as defined in Subclause 10.1 of [5, TS 38.213]. |
| - | Bandwidth part indicator - 0, 1 or 2 bits as determined by the number of DL |

BWPs n [symbol] configured by higher layers, excluding the initial DL bandwidth part. The
bitwidth for this field is determined as ┌log₂(n [symbol] )┐ bits, where

| | |
|---|---|
| - | n [symbol] = n [symbol] + 1 if n [symbol] ≤ 3, in which case the bandwidth part indicator is |

equivalent to the ascending order of the higher layer parameter BWP-Id;

| | |
|---|---|
| - | otherwise n [symbol] = n [symbol] , in which case the bandwidth part indicator is defined |

in Table 7.3.1.1.2-1;
If a UE does not support active BWP change via DCI, the UE ignores this bit field.

| | |
|---|---|
| - | Frequency domain resource assignment - number of bits determined by the |

following, where N [symbol] is the size of the active DL bandwidth part:

| | |
|---|---|
| - | N [symbol] bits if only resource allocation type 0 is configured, where N [symbol] is defined |

in Subclause 5.1.2.2.1 of [6, TS38.214],

| | |
|---|---|
| - | ┌log₂(N [symbol] (N [symbol] + 1)/2┐ bits if only resource allocation type 1 is |

configured, or

| | |
|---|---|
| - | max (┌log₂(N [symbol] (N [symbol] + 1)/2┐ , N [symbol] ) + 1 bits if both resource |

allocation type 0 and 1 are configured.

| | |
|---|---|
| - | If both resource allocation type 0 and 1 are configured, the MSB bit is used to |

indicate resource allocation type 0 or resource allocation type 1, where the bit value of 0
indicates resource allocation type 0 and the bit value of 1 indicates resource allocation type 1.

| | |
|---|---|
| - | For resource allocation type 0, the N [symbol] LSBs provide the resource allocation as |

defined in Subclause 5.1.2.2.1 of [6, TS 38.214].

| | |
|---|---|
| - | For resource allocation type 1, the ┌log₂(N [symbol] (N [symbol] + 1)/2┐ LSBs |

provide the resource allocation as defined in Subclause 5.1.2.2.2 of [6, TS 38.214]
If “Bandwidth part indicator” field indicates a bandwidth part other than the active
bandwidth part and if both resource allocation type 0 and 1 are configured for the indicated
bandwidth part, the UE assumes resource allocation type 0 for the indicated bandwidth part if
the bitwidth of the “Frequency domain resource assignment” field of the active bandwidth part
is smaller than the bitwidth of the “Frequency domain resource assignment” field of the
indicated bandwidth part.

| | |
|---|---|
| - | Time domain resource assignment - 0, 1, 2, 3, or 4 bits as defined in Subclause |

5.1.2.1 of [6, TS 38.214]. The bitwidth for this field is determined as ┌log₂(I)┐ bits, where I is
the number of entries in the higher layer parameter pdsch-TimeDomainAllocationList if the
higher layer parameter is configured; otherwise I is the number of entries in the default table.

| | |
|---|---|
| - | VRB-to-PRB mapping - 0 or 1 bit:- 0 bit if only resource allocation type 0 is |

configured or if interleaved VRB-to-PRB mapping is not configured by high layers;

| | |
|---|---|
| - | 1 bit according to Table 7.3.1.2.2-5 otherwise, only applicable to resource |

allocation type 1, as defined in Subclause 7.3.1.6 of [4, TS 38.211].

| | |
|---|---|
| - | PRB bundling size indicator - 0 bit if the higher layer parameter prb- |

BundlingType is not configured or is set to ‘static’, or 1 bit if the higher layer parameter prb-
BundlingType is set to ‘dynamic’ according to Subclause 5.1.2.3 of [6, TS 38.214].

| | |
|---|---|
| - | Rate matching indicator - 0, 1, or 2 bits according to higher layer parameters |

rateMatchPatternGroup1 and rateMatchPatternGroup2, where the MSB is used to indicate
rateMatchPatternGroup1 and the LSB is used to indicate rateMatchPatternGroup2 when there
are two groups.

| | |
|---|---|
| - | ZP CSI-RS trigger - 0, 1, or 2 bits as defined in Subclause 5.1.4.2 of [6, TS |

38.214]. The bitwidth for this field is determined as 109 ┌log₂(n [symbol] + 1)┐ bits, where n [symbol] is the
number of aperiodic ZP CSI-RS resource sets configured by higher layer.
For transport block 1:

| | |
|---|---|
| - | Modulation and coding scheme - 5 bits as defined in Subclause 5.1.3.1 of [6, |

TS 38.214]

| | |
|---|---|
| - | New data indicator - 1 bit |
| - | Redundancy version - 2 bits as defined in Table 7.3.1.1.1-2 |

For transport block 2 (only present if maxNrofCodeWordsScheduledByDCI equals 2):

| | |
|---|---|
| - | Modulation and coding scheme - 5 bits as defined in Subclause 5.1.3.1 of [6, |

TS 38.214]

| | |
|---|---|
| - | New data indicator - 1 bit |
| - | Redundancy version - 2 bits as defined in Table 7.3.1.1.1-2 |

If “Bandwidth part indicator” field indicates a bandwidth part other than the active
bandwidth part and the value of maxNrofCodeWordsScheduledByDCI for the indicated
bandwidth part equals 2 and the value of maxNrofCodeWordsScheduledByDCI for the active
bandwidth part equals 1, the UE assumes zeros are padded when interpreting the “Modulation
and coding scheme”, “New data indicator”, and “Redundancy version” fields of transport block
2 according to Subclause 12 of [5, TS38.213], and the UE ignores the “Modulation and coding
scheme”, “New data indicator”, and “Redundancy version” fields of transport block 2 for the
indicated bandwidth part.

| | |
|---|---|
| - | HARQ process number - 4 bits- Downlink assignment index - number of bits |

as defined in the following

| | |
|---|---|
| - | 4 bits if more than one serving cell are configured in the DL and the higher layer |

parameter pdsch-HARQ-ACK-Codebook=dynamic, where the 2 MSB bits are the counter DAI
and the 2 LSB bits are the total DAI;

| | |
|---|---|
| - | 2 bits if only one serving cell is configured in the DL and the higher layer |

parameter pdsch-HARQ-ACK-Codebook=dynamic, where the 2 bits are the counter DAI;

| | |
|---|---|
| - | 0 bits otherwise. |
| - | TPC command for scheduled PUCCH - 2 bits as defined in Subclause 7.2.1 of |

[5, TS 38.213]

| | |
|---|---|
| - | PUCCH resource indicator - 3 bits as defined in Subclause 9.2.3 of [5, TS |

38.213]

| | |
|---|---|
| - | PDSCH-to-HARQ_feedback timing indicator - 0, 1, 2, or 3 bits as defined in |

Subclause 9.2.3 of [5, TS 38.213]. The bitwidth for this field is determined as ┌log₂(I)┐ bits,
where I is the number of entries in the higher layer parameter dl-DataToUL-ACK.

| | |
|---|---|
| - | Antenna port(s) - 4, 5, or 6 bits as defined by Tables 7.3.1.2.2-1/2/3/4, where |

the number of CDM groups without data of values 1, 2, and 3 refers to CDM groups {0}, {0,1},
and {0, 1,2} respectively. The antenna ports [symbol] shall be determined according to the
ordering of DMRS port(s) given by Tables 7.3.1.2.2-1/2/3/4.
If a UE is configured with both dmrs-DownlinkForPDSCH-MappingTypeA and dmrs-
DownlinkForPDSCH-MappingTypeB, the bitwidth of this field equals max{x_{A},x_{B}}, where x_{A}
is the “Antenna ports” bitwidth derived according to dmrs-DownlinkForPDSCH-
MappingTypeA and x_{B} is the “Antenna ports” bitwidth derived according to dmrs-
DownlinkForPDSCH-MappingTypeB. A number of |x_{A} − x_{B}| zeros are padded in the MSB of
this field, if the mapping type of the PDSCH corresponds to the smaller value of x_{A} and x_{B}.

| | |
|---|---|
| - | Transmission configuration indication - 0 bit if higher layer parameter tci- |

PresentInDCI is not enabled; otherwise 3 bits as defined in Subclause 5.1.5 of [6, TS38.214].
If “Bandwidth part indicator” field indicates a bandwidth part other than the active
bandwidth part,

| | |
|---|---|
| - | if the higher layer parameter tci-PresentInDCI is not enabled for the CORESET |

used for the PDCCH carrying the DCI format 1_1,

| | |
|---|---|
| - | the UE assumes tci-PresentInDCI is not enabled for all CORESETs in the |

indicated bandwidth part;

| | |
|---|---|
| - | otherwise, |
| - | the UE assumes tci-PresentInDCI is enabled for all CORESETs in the indicated |

bandwidth part.

| | |
|---|---|
| - | SRS request - 2 bits as defined by Table 7.3.1.1.2-24 for UEs not configured |

with supplementaryUplink in ServingCellConfig in the cell; 3 bits for UEs configured with
supplementaryUplink in ServingCellConfig in the cell where the first bit is the non-SUL/SUL
indicator as defined in Table 7.3.1.1.1-1 and the second and third bits are defined by Table
7.3.1.1.2-24. This bit field may also indicate the associated CSI-RS according to Subclause
6.1.1.2 of [6, TS 38.214].

| | |
|---|---|
| - | CBG transmission information (CBGTI) - 0 bit if higher layer parameter |

codeBlockGroupTransmission for PDSCH is not configured, otherwise, 2, 4, 6, or 8 bits as
defined in Subclause 5.1.7 of [6, TS38.214], determined by the higher layer parameters
maxCodeBlockGroupsPerTransportBlock and maxNrofCodeWordsScheduledByDCI for the
PDSCH.

| | |
|---|---|
| - | CBG flushing out information (CBGFI) - 1 bit if higher layer parameter |

codeBlockGroupFlushIndicator is configured as “TRUE”, 0 bit otherwise.

| | |
|---|---|
| - | DMRS sequence initialization - 1 bit. |

[symbol]

indicates data missing or illegible when filed

Hereinafter, a method of allocating a time domain resource to a data channel in a 5G wireless communication system is described.

A base station may set a table for time domain resource allocation to a PDSCH and a PUSCH by higher layer signaling (e.g., RRC signaling). A table consisting of up to maxNrofDL-Allocations=16 entries may be set to the PDSCH and a table consisting of up to maxNrofUL-Allocations=16 entries may be set to the PUSCH. The time domain resource allocation information may include, for example, PDCCH-to-PDSCH slot timing (corresponding to a slot-wise time interval between a time point of receiving a PDCCH and a time point of transmitting a PDSCH scheduled by the received PDCCH, and displayed as K0) or PDCCH-to-PUSCH slot timing (corresponding to a slot-wise time interval between a time point of receiving a PDCCH and a time point of transmitting a PUSCH scheduled by the received PDCCH, and displayed as K2), information on a location and length of a start symbol in which a PDSCH or a PUSCH is scheduled in a slot, and a PDSCH or PUSCH mapping type. For example, the information shown in Table 8 and Table 9 below may be notified from the base station to the terminal.

TABLE 8
PDSCH-TimeDomainResourceAllocationList information element

PDSCH-TimeDomainResourceAllocationList ::= SEQUENCE (SIZE(1..maxNrofDL-
Allocations)) OF PDSCH-TimeDomainResourceAllocation
PDSCH-TimeDomainResourceAllocation ::= SEQUENCE {

| | | |
|---|---|---|
| k0 | INTEGER(0..32) | OPTIONAL, -- |

Need S
(PDCCH-to-PDSCH timing, slot-wise)

| | |
|---|---|
| mappingType | ENUMERATED {typeA, typeB}, |

(PDSCH mapping type)

| | |
|---|---|
| startSymbolAndLength | INTEGER (0..127) |

(Start symbol and length of PDSCH)
}

TABLE 9
PUSCH-TimeDomainResourceAllocation information element
PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {

| | |
|---|---|
| k2 | INTEGER(0..32) OPTIONAL, -- Need S |

(PDCCH-to-PUSCH timing, slot-wise)

| | |
|---|---|
| mappingType | ENUMERATED {typeA, typeB}, |

(PUSCH mapping type)

| | |
|---|---|
| startSymbolAndLength | INTEGER (0..127) |

(Start symbol and length of PUSCH)
}

The base station may notify the terminal of one of the entries of the table about the time domain resource allocation information through L1 signaling (e.g., DCI) (e.g., may indicate as a “time domain resource allocation” field in the DCI). The terminal may obtain the time domain resource allocation information on the PDSCH or the PUSCH based on the received DCI from the base station.

Hereinafter, a method of allocating a frequency domain resource to a data channel in a 5G wireless communication system is described.

In the 5G wireless communication system, two types, which are a resource allocation type 0 and a resource allocation type 1, may be supported as a method of indicating the frequency domain resource allocation information for a PDSCH and a PUSCH.

### Resource Allocation Type 0

The RB allocation information may be notified to the terminal from the base station in the form of a bitmap for a resource block group (RBG). In this case, the RBG may consist of a set of consecutive virtual RBs (VRBs), and a size P of the RBG may be determined based on a value set to an higher layer parameter (rbg-Size) and a size value of a BWP defined as nominal RBG size P in Table 10 shown below.

TABLE 10

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The total number of RBGs of a BWPi of which the size is N_{BWP,i}^{size} may be defined as follows.
N_{RBG}=┌(N_{BWP,i}^{size}+(N_{BWP,i}^{start}mod P))/P┐, where
the size of the first RBG is RBG₀^{size}=P−N_{BWP,i}^{start} mod P,
the size of last RBG is RBGₗₐₛₜ^{size}=(N_{BWP,i}^{start}+N_{BWP,i}^{size})mod P if (N_{BWP,i}^{start}+N_{BWP,i}^{start}+N_{BWP,i}^{size}) mod P>0 and P otherwise,
the size of all other RBGs is P.

Each bit of a bitmap having the size of N_{RBG} bit may correspond to each RBG. The RBGs may receive indexes in order of increasing frequency, starting from the lowest frequency location of a BWP. For N_{RBG} RBGs in the BWP, from RBG #0 to RBG #N_{RBG}−1 may be mapped from an MSB to an LSB of an RBG bitmap. If a specific bit value in the bitmap is 1, the terminal may determine that a corresponding RBG is allocated to the bit value, and if a specific bit value in the bitmap is 0, the terminal may determine that a corresponding RBG is not allocated to the bit value.

### Resource Allocation Type 1

RB allocation information may be notified to the terminal from the base station as the information on a start position and length of consecutively allocated VRBs. In this case, interleaving or non-interleaving may be additionally applied to the consecutively allocated VRBs. A resource allocation field of the resource allocation type 1 may consist of a resource indication value (RIV), and the RIV may consist of a start point RBₛₜₐᵣₜ of the VRB and a length L_{RBS} of the consecutively allocated RBs. More specifically, an RIV in a BWP having the size of N_{BWP}^{size} may be defined as follows.

$$if ( {L}_{RBs} - 1 ) \leq ⌊ {N}_{BWP}^{size} / 2 ⌋ then \\ RIV = {N}_{BWP}^{size} ( {L}_{RBs} - 1 ) + {RB}_{start} \\ else \\ RIV = {N}_{BWP}^{size} ( {N}_{BWP}^{size} - {L}_{RBs} + 1 ) + ( {N}_{BWP}^{size} - 1 - {RB}_{start} )$$

where L_{RBS}≥1 and shall not exceed N_{BWP}^{size}−N_{BWP}^{start}.

The base station may configure the terminal with a resource allocation type through higher layer signaling (e.g., an higher layer parameter resourceAllocation may be set to one of resourceAllocationType0, resourceAllocationType1, and dynamicSwitch). If the terminal is configured with the both the resource allocation types 0 and 1 (or identically, if the higher layer parameter resourceAllocation is set to dynamicSwitch), the base station may indicate whether a bit corresponding to a most significant bit (MSB) of a field indicating resource allocation in the DCI format indicating scheduling is the resource allocation type 0 or the resource allocation type 1. In addition, resource allocation information may be indicated by remaining bits other than the bit corresponding to the MSB based on the indicated resource allocation type and the terminal may interpret resource allocation field information of a DCI field based thereon. If the terminal is configured with one of the resource allocation type 0 and the resource allocation type 1 (or identically, if the higher layer parameter resourceAllocation is set to one of resourceAllocationType0 and resourceAllocationType1), resource allocation information may be indicated based on a resource allocation type in which a field indicating resource allocation in a DCI format indicating scheduling, and the terminal may interpret resource allocation field information of a DCI field based thereon.

Hereinafter, a modulation and coding scheme (MCS) used by a 5G wireless communication system is further described.

In 5G, a plurality of MCS index tables may be defined for PDSCH and PUSCH scheduling. Among the plurality of MCS tables, a MCS table assumed by the terminal may be set or indicated by higher layer signaling or L1 signaling from the base station to the terminal or an RNTI value assumed by the terminal during PDCCH decoding.

An MCS index table 1 for a PDSCH and a CP-OFDM-based PUSCH (or a PUSCH without transform precoding) may be the same as Table 11 (MCS index table 1 for PDSCH) shown below.

TABLE 11

| MCS Index | Modulation | Target code Rate | Spectral |
|---|---|---|---|
| IMCS | Order Qm | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

An MCS index table 2 for a PDSCH and a CP-OFDM-based PUSCH (or a PUSCH without transform precoding) may be the same as Table 12 (MCS index table 2 for PDSCH) shown below.

TABLE 12

| MCS Index | Modulation | Target code Rate | Spectral |
|---|---|---|---|
| IMCS | Order Qm | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

An MCS index table 3 for a PDSCH and a CP-OFDM-based PUSCH (or a PUSCH without transform precoding) may be the same as Table 13 (MCS index table 3 for PDSCH) shown below.

TABLE 13

| MCS Index | Modulation | Target code Rate | Spectral |
|---|---|---|---|
| IMCS | Order Qm | R × [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |

| | | |
|---|---|---|
| 29 | 2 | reserved |
| 30 | 4 | reserved |
| 31 | 6 | reserved |

An MCS index table 1 for DFT-s-OFDM-based PUSCH (or a PUSCH with transform precoding) may be the same as Table 14 (MCS index table for PUSCH with transform precoding and 64 QAM) shown below.

TABLE 14

| MCS Index | Modulation | Target code Rate | Spectral |
|---|---|---|---|
| IMCS | Order Qm | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

An MCS index table 2 for DFT-s-OFDM-based PUSCH (or a PUSCH with transform precoding) may be the same as Table 15 (MCS index table 2 for PUSCH with transform precoding and 64QAM) shown below.

TABLE 15

| MCS Index | Modulation | Target code Rate | Spectral |
|---|---|---|---|
| IMCS | Order Qm | R × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

An MCS index table for a PUSCH to which transform precoding (transform precoding or discrete Fourier transform (DFT) precoding) and 64 QAM are applied may be the same as Table 16 shown below.

TABLE 16

| MCS Index | Modulation | Target code Rate | Spectral |
|---|---|---|---|
| IMCS | Order Qm | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

An MCS index table for a PUSCH to which transform precoding (transform precoding or DFT precoding) and 64 QAM are applied may be the same as Table 17 shown below.

TABLE 17

| MCS Index | Modulation | Target code | Spectral |
|---|---|---|---|
| IMCS | Order Qm | Rate R × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

Hereinafter, a DL control channel in a 5G wireless communication system is further described with reference to drawings.

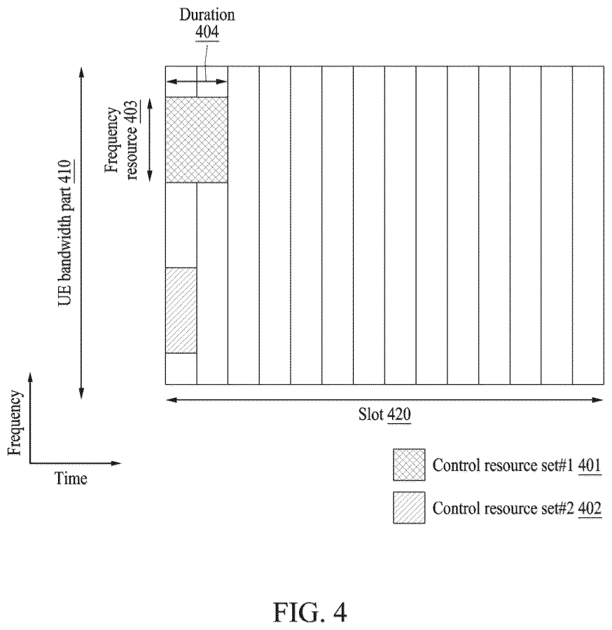

FIG. 4 is a diagram of an example of a control resource set (CORESET) in which a control channel is transmitted in a 5G wireless communication system.

Referring to FIG. 4, a UE bandwidth part 410 of a terminal may be configured in a frequency axis, and two control resource sets, a control resource set #1 401 and a control resource set #2 402, may be configured in one slot 420 on a time axis. The control resource sets 401 and 402 may be configured to a specific frequency resource 403 in the entire UE bandwidth part 410 on the frequency axis. In addition, the control resource sets 401 and 402 may be configured with one or more OFDM symbols on the time axis and this may be defined as a control resource set duration 404. Referring to the example of FIG. 4, the control resource set #1 401 may be configured as a control resource set duration of two symbols, and the control resource set #2 402 may be configured as a control resource duration of one symbol.

The control resource set in the 5G wireless communication system described above may be configured by the base station to the terminal through higher layer signaling (e.g., SI, MIB, RRC signaling). Configuring a control resource to a terminal may be providing information, such as a control resource set identifier, a frequency location of the control resource set, and a symbol length of the control resource set. For example, the information from Table 18 shown below may be included.

TABLE 18

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(Control resource set identifier (Identity))

| | |
|---|---|
| frequencyDomainResources | BIT STRING (SIZE (45)), |

(Frequency axis resource allocation information)

| | |
|---|---|
| duration | INTEGER |

(1..maxCoReSetDuration),
(Time axis resource allocation information)

| | |
|---|---|
| cce-REG-MappingType | CHOICE |

```
{
  (CCE-to-REG mapping scheme)
          interleaved
        SEQUENCE {
              reg-BundleSize
        ENUMERATED {n2, n3, n6},
      (REG bundle size)
              precoderGranularity
        ENUMERATED {sameAsREG-bundle, allContiguousRBs},
              interleaverSize
        ENUMERATED {n2, n3, n6}
              (Interleaver size)
              shiftIndex
        INTEGER(0..maxNrofPhysicalResourceBlocks-1)
                OPTIONAL
            (Interleaver Shift)
```

| | |
|---|---|
| }, | NULL |

```
        nonInterleaved
        },
        tci-StatesPDCCH
        SEQUENCE(SIZE (1..maxNrofTCI-StatesPDCCH)) OF TCI-StateId
              OPTIONAL,
  (QCL configuration information)
```

| | |
|---|---|
| tci-PresentInDCI | ENUMERATED |

{enabled}
OPTIONAL, -- Need S
}

In Table 18, tci-StatesPDCCH (simply referred to as a TCI state) configuration information may include information on a CSI-reference signal (CSI-RS) index or one or a plurality of SS/PBCH block indexes in a QCL relationship with a DMRS transmitted from a corresponding control resource set.

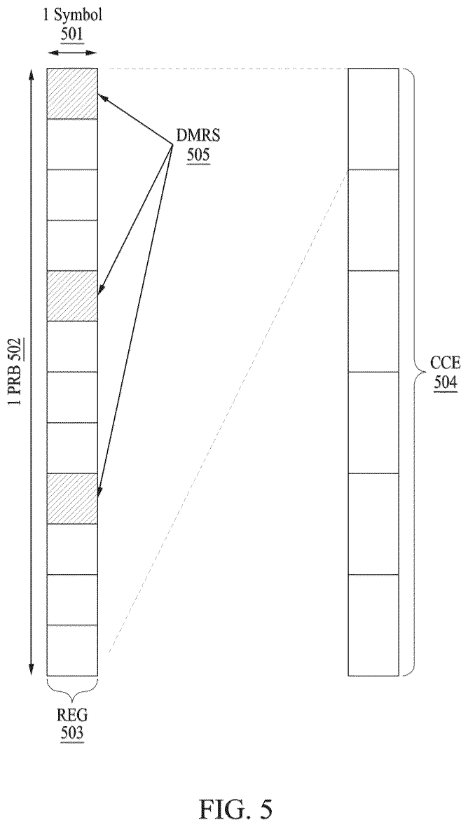

FIG. 5 is a diagram illustrating a structure of a downlink control channel of a 5G wireless communication system.

In other words, FIG. 5 is a diagram showing an example of a basic unit of time and frequency resources constituting a DL control channel usable in the 5G wireless communication system.

Referring to FIG. 5, a basic unit of time and frequency resources constituting the control channel may be a resource element group (REG) 503, and the REG 503 may be defined by one OFDM symbol 501 on a time axis and one PRB 502 on a frequency axis, in other words, 12 subcarriers. The base station may configure a DL control channel allocation unit by concatenating the REG 503.

As shown in FIG. 5, when a basic unit of allocating a DL control channel in the 5G wireless communication system is a control channel element (CCE) 504, one CCE 504 may consist of a plurality of REGs 503. Based on the example of the REG 503 shown in FIG. 5, the REG 503 may consist of 12 REs and if one CCE 504 consists of six REGs 503, one CCE 504 may consist of 72 REs. When a DL control resource set is configured, a corresponding area may consist of a plurality of CCEs 504, and a specific DL control channel may be mapped by one or the plurality of CCEs 504 according to an aggregation level (AL) in the control resource set and may be transmitted. The CCEs 504 in the control resource set may be distinguished by numbers and in this case, the numbers of the CCEs 504 may be assigned according to a logical mapping scheme.

The basic unit of the DL control channel shown in FIG. 5, in other words, the REG 503 may include REs to which DCI is mapped, and an area to which a DMRS 505, which is a reference signal to decode the DCI, is mapped. As shown in FIG. 5, three DMRSs 505 in one REG 503 may be transmitted. The number of CCEs required to transmit a PDCCH may be 1, 2, 4, 8, and 16 depending on the AL, and the different CCE numbers may be used to implement link adaptation of a DL control channel. For example, when AL is L, one DL control channel may be transmitted through L CCEs. The terminal may need to detect a signal while the terminal does not know information on the DL control channel, and a search space representing a set of CCEs may be defined for blind decoding. The search space may be a set of DL control channel candidates including CCEs that the terminal needs to attempt to decode at a given AL, and since there are various ALs that makes one group with 1, 2, 4, 8, and 16 CCEs, the terminal may have a plurality of search spaces. A search space set may be defined as a set of search spaces at all set ALs.

The search space may be classified as a common search space and a UE-specific search space. Terminals of a certain group or all terminals may search a common search space of a PDCCH to receive dynamic scheduling for system information or cell common control information, such as a paging message. For example, PDSCH scheduling allocation information for transmission of an SIB including business information of a cell may be received by searching the common search space of the PDCCH. Since the terminals of a certain group or all terminals need to receive a PDCCH, the common search space may be defined as a set of pre-arranged CCEs. The scheduling allocation information of a UE-specific PDSCH or PUSCH may be received by searching for a UE-specific search space of the PDCCH. The UE-specific search space may be UE-specifically defined as a function of various system parameters and the identity of the terminal.

In the 5G wireless communication system, a parameter for the search space of the PDCCH may be configured in the terminal by the base station through higher layer signaling (e.g., SIB, MIB, RRC signaling). For example, the base station may configured the terminal with the number of PDCCH candidates at the aggregation level L, a monitoring period for the search space, a symbol-wise monitoring occasion in a slot for the search space, a search space type (a common search space or a UE-specific search space), a combination of an RNTI and a DCI format to be monitored in the search space, and a control resource set index to monitor the search space, to the terminal. For example, a parameter related to a search space for a PDCCH may include the information shown in Table 19 below.

TABLE 19

| | |
|---|---|
| SearchSpace ::= | SEQUENCE { |

-- Identity of the search space. SearchSpaceId = 0 identifies the SearchSpace configured
via PBCH (MIB) or ServingCellConfigCommon.

| | |
|---|---|
| searchSpaceId | SearchSpaceId, |

(Search space ID)

| | |
|---|---|
| controlResourceSetId | ControlResourceSetId, |

(Control resource set ID)

| | |
|---|---|
| monitoringSlotPeriodicityAndOffset | CHOICE { |

```
  (Monitoring slot level period)
      sl1
    NULL,
      sl2
    INTEGER (0..1);
      sl4
    INTEGER (0..3);
      sl5
    INTEGER(0..4);
      sl8
    INTEGER(0..7);
      sl10
    INTEGER(0..9);
```

| | |
|---|---|
| sl16 | INTEGER |

(0..15);

| | |
|---|---|
| sl20 | INTEGER |

```
(0..19)
    }
    OPTIONAL,
  duration (monitoring duration) INTEGER (2..2559)
```

| | |
|---|---|
| monitoringSymbolsWithinSlot | BIT STRING |
| (SIZE (14)) | OPTIONAL, |

(Monitoring symbol in slot)

| | |
|---|---|
| nrofCandidates | SEQUENCE { |

(Number of PDCCH candidates by aggregation level)

| | |
|---|---|
| aggregationLevel1 | ENUMERATED |

{n0, n1, n2, n3, n4, n5, n6, n8},

| | |
|---|---|
| aggregationLevel2 | ENUMERATED |

{n0, n1, n2, n3, n4, n5, n6, n8},

| | |
|---|---|
| aggregationLevel4 | ENUMERATED |

{n0, n1, n2, n3, n4, n5, n6, n8},

| | |
|---|---|
| aggregationLevel8 | ENUMERATED |

{n0, n1, n2, n3, n4, n5, n6, n8},

| | |
|---|---|
| aggregationLevel16 | ENUMERATED |

```
{n0, n1, n2, n3, n4, n5, n6, n8}
    },
          searchSpaceType
      CHOICE {
          (Search space type)
            -- Configures this search space as common search space (CSS)
and DCI formats to monitor.
            common
          SEQUENCE {
          (Common search space)
        }
            ue-Specific
      SEQUENCE {
          (UE-specific search space)
              -- Indicates whether the UE monitors in this USS for DCI
formats 0-0 and 1-0 or for formats 0-1 and 1-1.
              formats
            ENUMERATED {formats0-0-And-1-0, formats0-1-And-1-1},
              ...
            }
```

Depending on the configuration information, the base station may configured one or a plurality of search space sets to the terminal. According to an embodiment, the base station may configure the terminal with a search space set 1 and a search space set 2. In the search space set 1, the base station may configure the terminal to monitor a DCI format A scrambled by an X-RNTI in a common search space, and in the search space set 2, the base station may configure the terminal to monitor a DCI format B scrambled by a Y-RNTI in a UE-specific search space.

According to the configuration information, one or a plurality of search space sets may exist in a common search space or a UE-specific search space. For example, a search space set #1 and a search space set #2 may be set as a common search space, and a search space set #3 and a search space set #4 may be set as a UE-specific search space.

In the common search space, a combination of a DCI format and an RNTI shown below may be monitored. The example is not limited thereto.
DCI format 0_0/1_0 with CRC scrambled by C-RNTI, CS-RNTI, MCS-C-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, a combination of a DCI format and an RNTI shown below may be monitored. The example is not limited thereto.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the definitions and purposes described below.
C-RNTI: for UE-specific PDSCH scheduling
MCS-C-RNTI: for UE-specific PDSCH scheduling
Temporary cell (TC)-RNTI: for UE-specific PDSCH scheduling
Configured scheduling (CS)-RNTI: for semi-statically configured UE-specific PDSCH scheduling
RA-RNTI: for PDSCH scheduling in a random access stage
Paging (P)-RNTI: for PDSCH scheduling to which paging is transmitted
SI-RNTI: for PDSCH scheduling to which system information is transmitted
Interruption (INT)-RNTI: for notifying of puncturing for the PDSCH
TPC-PUSCH-RNTI: for indicating a power control command to the PUSCH
TPC-PUCCH-RNTI: for indicating a power control command to the PUCCH
TPC-SRS-RNTI: for indicating a power control command to an SRS

The DCI formats described above may follow the definitions shown in Table 20 below.

TABLE 20

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In the 5G wireless communication system, in a control resource set p and a search space set s, a search space of an aggregation level L may be expressed as the following equation.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad [ Equation 1 ]$$

L: aggregation level
n_{CI}: carrier index
N_{CCE,p}: total number of CCEs in the control resource set p
n^{μ}_{s,f}: slot index
M^{(L)}_{p,s,max}: number of PDCCH candidates at aggregation level L
M_{snCI}=0, . . . , M^{(L)}_{p,s,max}−1: PDCCH candidate index at aggregation level L
i=0, . . . , L−1
Y_{p,n}_{ₛ}_{,f}^{μ}=(Aₚ·Y_{p,n,}_{_{s,f}}^{μ}−1) mod D, Yₚ₋₁=n_{RNTI}≠0, A₀=39827, A₁=39829, A₂=39839, D=65537
n_{RNTI}: terminal ID

In the case of a common search space, a Y_(p,n^{μ}_{s,f}) value may correspond to 0.

In the case of a UE-specific search space, the Y_(p,n^{μ}_{s,f}) value may correspond to a value that varies depending on the identify (C-RNTI or ID configured in the terminal by the base station) and a time index.

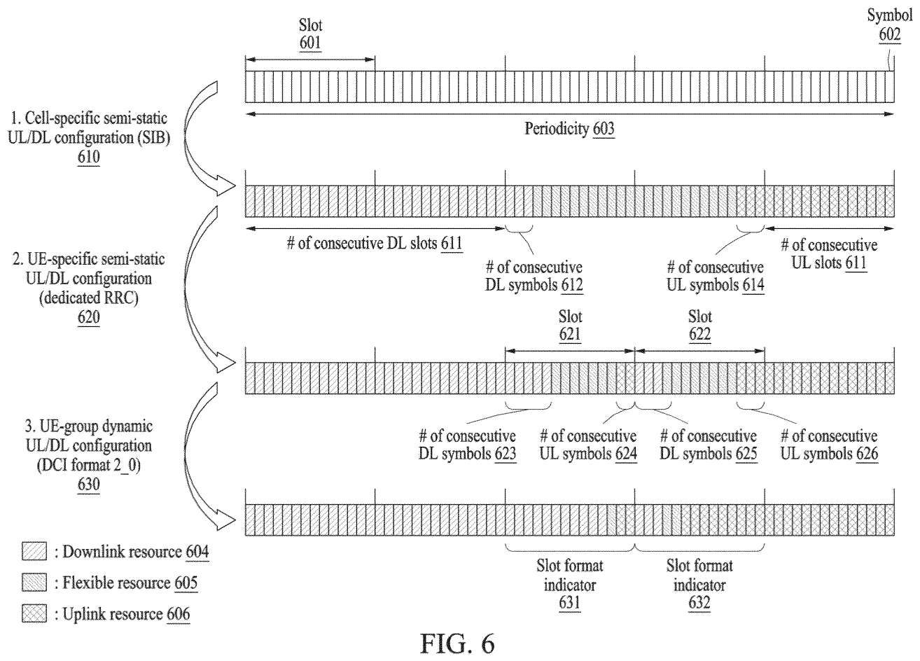

FIG. 6 is a diagram of an example of a method of configuration uplink and downlink resources of a 5G wireless communication system.

Referring to FIG. 6, a slot 601 may include 14 symbols 602. In the 5G communication system, UL-DL configurations of a symbol/slot may be performed in three steps.

First, a UL-DL of a symbol/slot may be semi-statically configured in a symbol through cell-specific configuration information 610 through system information. Specifically, the cell-specific UL-DL configuration information through the system information may include UL-DL pattern information and reference subcarrier information. The UL-DL pattern information may indicate a pattern periodicity 603, the number 611 of consecutive DL slots from a start point of each pattern, the number 612 of symbols of a following slot, the number 613 of consecutive UL slots from an end of the pattern, and the number 614 of symbols of a following slot. In this case, a slot and a symbol, which are not indicated by the UL and the DL, may be determined to be a flexible slot and a flexible symbol.

Second, through user-specific configuration information through dedicated higher layer signaling, slots 621 and 622 including a flexible slot or a flexible symbol may be indicated by numbers 623 and 625 of consecutive DL symbols from start symbols of the respective slots and numbers 624 and 626 of consecutive UL symbols from ends of the respective slots, or may be indicated by the entire slot DL or the entire slot UL.

Third, to dynamically change DL signal transmission and UL signal transmission sections, the symbols indicated by a flexible symbol in each slot (in other words, the symbols that are not indicated by the DL and the UL) may be indicated whether each symbol is a DL symbol, a UL symbol, or a flexible symbol, by slot format indicators (SFIs) 631 and 632 included in the DL control channel. The SFI may be selected by one index in a table in which 14 symbols of a UL-DL configuration in one slot is preset as shown in Table 21 (or Table 34 to be described below) below.

TABLE 21

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on tdd-UL-DL- |
| | ConfigurationCommon, or tdd-UL-DL-ConfigurationDedicated and, |
| | if any, on detected DCI formats |

In an NR system, the terminal may transmit control information (uplink control information: UCI) to the base station through a PUCCH. The control information may include at least one of HARQ-ACK indicating the success of demodulation/decoding with respect to a transport block (TB) that the terminal receives through a PDSCH, a scheduling request (SR) requested by the terminal to a PUSCH base station for resource allocation to transmit uplink data, and CSI, which is information for reporting a channel state of the terminal.

A PUCCH resource may be divided into a long PUCCH and a short PUCCH depending on the length of an allocated symbol. In the NR system, a long PUCCH may have a length of at least four symbols in a slot, and a short PUCCH may have a length of less than or equal to two symbols in a slot.

To further describe the long PUCCH, the long PUCCH may be used to improve uplink cell coverage and therefore, may be transmitted in a DFT-S-OFDM scheme, which is single carrier transmission, rather than OFDM transmission. The long PUCCH may support transmission formats, such as PUCCH format 1, PUCCH format 3, and PUCCH format 4, depending on whether terminal multiplexing is supported through pre-DFT OCC support in an IFFT frontend and the number of supportable control information bits.

Firstly, the PUCCH format 1 may be a DFT-S-OFDM-based long PUCCH format capable of supporting control information up to 2 bits and may use a frequency resource by one RB. The control information may include each or a combination of HARQ-ACK and an SR. The PUCCH format 1 may iteratively include an OFDM symbol including a DMRS, which is a reference signal for demodulation, and an OFDM symbol including the UCI.

For example, when the number of transmission symbols of the PUCCH format 1 is eight, from a first starting symbol of the eight symbols, the symbols may be a DMRS symbol, a UCI symbol, a DMRS symbol, a UCI symbol, a DMRS symbol, a UCI symbol, a DMRS symbol, and a UCI symbol. The DMRS symbol may be spread using an orthogonal code (or an orthogonal sequence or a spreading code, wᵢ(m)) on the time axis in a sequence corresponding to a length of 1 RB on the frequency axis in one OFDM symbol and may be transmitted after IFFT is performed.

The UCI symbol may be transmitted after the terminal generates d(0) by performing BPSK modulation on 1 bit control information and QPSK modulation on 2 bits control information, scrambles the generated d(0) by multiplying the generated d(0) by a sequence corresponding to a length of 1 RB on a frequency domain, spreads the scrambled sequence on a time domain by using an orthogonal code (or an orthogonal sequence or spreading code wᵢ(m)), and performs IFFT on the spread sequence.

The terminal may generate a sequence based on a configured ID and group hopping or sequence hopping configuration configured by higher layer signaling from the base station, and may generate a sequence corresponding to the length of 1 RB by cyclic shifting the generated sequence with an initial cyclic shift (CS) value configured via an upper signal.

wᵢ(m) may be determined as

$${w}_{i} ( m ) = {e}^{\frac{j 2 πΦ ( m )}{{N}_{SF}}}$$

when the length (N_{SF}) of a spreading code is given, and specifically, is given as in Table 22 shown below. i may denote an index of the spreading code and m may denote an index of elements of the spreading code. In this case, numbers in the bracket [ ] in Table 22 may denote Φ(m), and for example, when the length of the spreading code is 2 and an index i of the set spreading code is 0, a spreading code w_i(m) may be wᵢ(0)=e^{jπ·0/N}^{_{SF}}=1, wᵢ(1)=e^{jπ·0/N}^{_{SF}}=1 and thereby, wᵢ(m)=[1 1].

TABLE 22

| | Ø | | | | | | |
|---|---|---|---|---|---|---|---|
| N_{SF, m}^{PUCCH, 1} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

Next, the PUCCH format 3 may be a DFT-S-OFDM-based long PUCCH format capable of supporting control information of more than 2 bits and the number of used RBs may be configured through an higher layer. The control information may include each or a combination of HARQ-ACK, SR, and CSI. In the PUCCH format 3, a DMRS symbol location may be proposed in the following Table 23 depending on frequency hopping in a slot and additional DMRS symbol configuration.

TABLE 23

| DM-RS position l within PUCCH span | |
|---|---|
| No additional DM-RS | Additional DM-RS |

| PUCCH | No | | No | |
|---|---|---|---|---|
| length | hopping | Hopping | hopping | Hopping |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, when the number of transmission symbols of the PUCCH format 3 is eight symbols, a first starting symbol of the eight symbols may start with 0 and a DMRS may be transmitted to a first symbol and a fifth symbol. [Table 23] may identically apply to a DMRS symbol location of a PUCCH format 4.

Next, the PUCCH format 4 may be a DFT-S-OFDM-based long PUCCH format capable of supporting control information of more than 2 bits, and may use a frequency resource by 1 RB. The control information may include each or a combination of HARQ-ACK, SR, and CSI. The PUCCH format 4 may be different from the PUCCH format 3 in an aspect that the PUCCH format 4 may multiplex the PUCCH format 4 of various terminals in one RB. The PUCCH format 4 of multiple terminals may be possible by applying pre-DFT orthogonal cover code (OCC) to the control information in IFFT frontend. However, the number of control information symbols transmitted by one terminal may decrease depending on the number of multiplexed terminals. The number of multiplexed terminals, in other words, the number of usable different OCCs may be 2 or 4, and the number of OCCs and an OCC index to be applied may be configured through an higher layer.

Next, a short PUCCH is described. A short PUCCH may be transmitted by both a DL centric slot and a UL-centric slot, and typically, may be transmitted by a last symbol of a slot, or an OFDM symbol in a rear portion (e.g., a last OFDM symbol, a second to last OFDM symbol, or last two OFDM symbols). The short PUCCH may be transmitted by an arbitrary location in the slot. In addition, the short PUCCH may be transmitted using one OFDM symbol or two OFDM symbols. The short PUCCH may be used to reduce latency compared to the long PUCCH in the case of decent UL cell coverage and may be transmitted by CP-OFDM.

The short PUCCH may support transmission formats, such as the PUCCH format 0 and the PUCCH format 2, depending on the number of supportable control information bits. Firstly, the PUCCH format 0 may be a short PUCCH format capable of supporting control information up to 2 bits and may use a frequency resource by 1 RB. The control information may include each or a combination of HARQ-ACK and an SR. The PUCCH format 0 may not transmit a DMRS and may have a structure for transmitting only a sequence mapped onto 12 subcarriers on the frequency axis in one OFDM symbol. The terminal may generate a sequence based on group hopping or sequence hopping configuration configured from the base station through an upper signal and configured ID, may cyclic-shift the generated sequence by using a final cyclic shift (CS) value obtained by adding a different CS value to an indicated initial CS value according to ACK or NACK, may map the cyclic-shifted sequence to 12 subcarriers, and transmit the mapped sequence.

For example, when HARQ-ACK is 1 bit, the terminal may generate a final CS by adding 6 to an initial CS value in the case of ACK as shown in Table 24 below, and may generate a final CS by adding 0 to an initial CS value in the case of NACK. “0” that is a CS value for NACK and “6” that is a CS value for ACK may be defined in the standard, and the terminal may transmit 1-bit HARQ-ACK by generating the PUCCH format 0 according to the value defined in the standard.

TABLE 24

| HARQ-ACK Value | 0 | 1 |
|---|---|---|
| Sequence cyclic shift | m_{cs} = 0 | m_{cs} = 6 |

For example, when HARQ-ACK is 2 bits, the terminal may add 0 to an initial CS value in the case of (NACK, NACK) as shown in Table 25 below, may add 3 to the initial CS value in the case of (NACK, ACK), may add 6 to the initial CS value in the case of (ACK, ACK), and may add 9 to the initial CS value in the case of (ACK, NACK). 0 that is a CS value for (NACK, NACK), 3 that is a CS value for (NACK, ACK), 6 that is a CS value for (ACK, ACK), and 9 that is a CS value for (ACK, NACK) may be defined in the standard and the terminal may transmit a 2-bit HARQ-ACK by generating a PUCCH format 0 depending on a value defined in the standard.

When a final CS value obtained by adding a CS value according to ACK or NACK to the initial CS value exceeds 12, the length of sequence may be 12, and thereby, modulo 12 may apply to the final CS value.

TABLE 25

| HARQ-ACK Value | {0, 0} | {0, 1} | {1, 1} | {1, 0} |
|---|---|---|---|---|
| Sequence cyclic | m_{cs} = 0 | m_{cs} = 3 | m_{cs} = 6 | m_{cs} = 9 |
| shift | | | | |

Next, the PUCCH format 2 may be a short PUCCH format that supports control information exceeding 2 bits and the number of used RBs may be configured via an higher layer. The control information may include each or a combination of HARQ-ACK, SR, and CSI. When an index of the first subcarrier is #0, in PUCCH format 2, locations of subcarriers transmitting a DMRS in one OFDM symbol may be fixed to subcarriers having indexes of #1, #4, #7, and #10. After channel encoding and modulation, the control information may be mapped onto remaining subcarriers other than the subcarrier where the DMRS is located.

In addition, multi-slot repetition may be supported for the PUCCH formats 1, 3, and 4 to improve UL coverage and PUCCH repetition may be configured for each PUCCH format. The terminal may perform iterative transmission to a PUCCH including UCI by the number of slots configured through nrofSlots that is higher layer signaling. For iterative PUCCH transmission, PUCCH transmission of each slot may be performed using the same number of consecutive symbols, and the number of consecutive symbols may be configured through nrofSymbols that is higher layer signaling in PUCCH-format 1, PUCCH-format 3, or PUCCH-format 4. For iterative PUCCH transmission, the PUCCH transmission of each slot may be performed using a same starting symbol and the same starting symbol may be configured via startingSymbolIndex that is higher layer signaling in PUCCH-format 1, PUCCH-format 3, or PUCCH-format 4. For iterative PUCCH transmission, a single PUCCH-spatialRelationInfo may be configured for a single PUCCH resource. For iterative PUCCH transmission, if the terminal is configured to perform frequency hopping in the PUCCH transmission in different slots, the terminal may perform frequency hopping slot-wise. In addition, if the terminal is configured to perform frequency hopping in the PUCCH transmission in different slots, in an even-numbered slot, the terminal may start the PUCCH transmission from a first PRB index configured via startingPRB that is higher layer signaling, and in an odd-numbered slot, the terminal may start the PUCCH transmission from a second PRB index configured via secondHopPRB that is higher layer signaling. In addition, if the terminal is configured to perform frequency hopping in the PUCCH transmission in different slots, an index of a slot indicated to the terminal for the first PUCCH transmission may be 0, and during the entire configured PUCCH iterative transmissions, the number of PUCCH iterative transmissions may increase regardless of the PUCCH transmission in each slot. If the terminal is configured to perform frequency hopping in the PUCCH transmission in different slots, the terminal may not expect to configuration of frequency hopping in a slot during the PUCCH transmission. If the terminal is not configured to perform frequency hopping in the PUCCH transmission in different slots and is configured with frequency hopping within a slot, the first and second PRB indexes may be identically applied in the slot. If the number of UL symbols capable of PUCCH transmission is less than nrofSymbols configured via higher layer signaling, the terminal may not transmit a PUCCH. Even if the terminal fails to transmit a PUCCH for some reason in a slot during the PUCCH iterative transmissions, the terminal may increase the number of PUCCH iterative transmissions.

Next, PUCCH resource configuration of a base station or a terminal is described. The base station may configured a PUCCH resource for each BWP through an higher layer to a specific terminal. The PUCCH resource configuration may be as shown in Table 26 below.

TABLE 26

| | |
|---|---|
| PUCCH-Config ::= | SEQUENCE { |
| resourceSetToAddModList | SEQUENCE (SIZE (1..maxNrofPUCCH-ResourceSets)) |

| | |
|---|---|
| OF PUCCH-ResourceSet | OPTIONAL, -- Need N |

| | |
|---|---|
| resourceSetToReleaseList | SEQUENCE (SIZE (1..maxNrofPUCCH-ResourceSets)) |

| | |
|---|---|
| OF PUCCH-ResourceSetId | OPTIONAL, -- Need N |

| | |
|---|---|
| resourceToAddModList | SEQUENCE (SIZE (1..maxNrofPUCCH-Resources)) |

| | |
|---|---|
| OF PUCCH-Resource | OPTIONAL, -- Need N |

| | |
|---|---|
| resourceToReleaseList | SEQUENCE (SIZE (1..maxNrofPUCCH-Resources)) OF |

PUCCH-ResourceId OPTIONAL, -- Need N

| | |
|---|---|
| format1 | SetupRelease { PUCCH-FormatConfig } |

OPTIONAL, -- Need M

| | |
|---|---|
| format2 | SetupRelease { PUCCH-FormatConfig } |

OPTIONAL, -- Need M

| | |
|---|---|
| format3 | SetupRelease { PUCCH-FormatConfig } |

OPTIONAL, -- Need M

| | |
|---|---|
| format4 | SetupRelease { PUCCH-FormatConfig } |

OPTIONAL, -- Need M

| | |
|---|---|
| schedulingRequestResourceToAddModList | SEQUENCE (SIZE (1..maxNrofSR- |

Resources)) OF SchedulingRequestResourceConfig

OPTIONAL, -- Need N

schedulingRequestResourceToReleaseList SEQUENCE (SIZE (1..maxNrofSR-Resources))
OF SchedulingRequestResourceId

OPTIONAL, -- Need N

| | |
|---|---|
| multi-CSI-PUCCH-ResourceList | SEQUENCE (SIZE (1..2)) OF PUCCH-ResourceId |

OPTIONAL, -- Need M

| | |
|---|---|
| dl-DataToUL-ACK | SEQUENCE (SIZE (1..8)) OF INTEGER (0..15) |

OPTIONAL, -- Need M

| | |
|---|---|
| spatialRelationInfoToAddModList | SEQUENCE (SIZE |

(1..maxNrofSpatialRelationInfos)) OF PUCCH-SpatialRelationInfo

OPTIONAL, -- Need N

| | |
|---|---|
| spatialRelationInfoToReleaseList | SEQUENCE (SIZE (1..maxNrofSpatialRelationInfos)) |

OF PUCCH-SpatialRelationInfoId

| | | OPTIONAL, -- Need N |
|---|---|---|
| pucch-PowerControl | PUCCH-PowerControl | OPTIONAL, |

-- Need M
...
}

According to Table 26, one or multiple PUCCH resource sets may be configured for a specific BWP in PUCCH resource configuration, and a maximum payload value for UCI transmission may be configured in a portion of the PUCCH resource sets. One or multiple PUCCH resources may belong to each PUCCH resource set and each PUCCH resource may belong to one of the PUCCH formats described above.

For the PUCCH resource set, a maximum payload value of a first PUCCH resource set may be fixed to 2 bits. Accordingly, a corresponding value may not be separately configured through an higher layer and the like. If a remaining PUCCH resource set is configured, an index of the PUCCH resource set may be configured in ascending order of the maximum payload value, and a maximum payload value may not be configured for the last PUCCH resource set. The higher layer configuration for the PUCCH resource set may be as shown in Table 27 below.

TABLE 27

| | |
|---|---|
| -- A set with one or more PUCCH resources | |
| PUCCH-ResourceSet ::= | SEQUENCE { |
| pucch-ResourceSetId | PUCCH-ResourceSetId, |
| resourceList | SEQUENCE (SIZE (1..maxNrofPUCCH-ResourcesPerSet)) |
| OF PUCCH-ResourceId, | |
| maxPayloadSize | INTEGER (4..256) OPTIONAL |
| -- Need R | |
| } | |

IDs of PUCCH resources belonging to the PUCCH resource set may be included in resourceList parameters of Table 27.

In the case of an initial connection or if a PUCCH resource set is not configured, a PUCCH resource set of Table 28 configured by multiple cell-specific PUCCH resources in an initial BWP may be used. A PUCCH resource used for the initial connection in the PUCCH resource set may be indicated by an SIB 1.

TABLE 28

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}/4┘ | {0, 3, 6, 9} |

Each maximum payload of PUCCH resources included in the PUCCH resource set may be 2 bits in the case of PUCCH format 0 or 1, and the maximum payload for other formats may be determined by the symbol length, the number of PRBs, and a maximum code rate. The symbol length and the number of PRBs may be configured for each PUCCH resource and the maximum code rate may be configured for each PUCCH format.

Next, PUCCH resource selection for UCI transmission is described. In the case of SR transmission, a PUCCH resource for an SR corresponding to schedulingRequestID as shown in Table 29 may be configured through an higher layer. The PUCCH resource may be a resource belonging to the PUCCH format 0 or the PUCCH format 1.

TABLE 29

| SchedulingRequestResourceConfig ::= | | SEQUENCE { |
|---|---|---|
| schedulingRequestResourceId | | SchedulingRequestResourceId, |
| schedulingRequestID | SchedulingRequestId, | |
| periodicityAndOffset | CHOICE { | |
| sym2 | NULL, | |
| sym6or7 | NULL, | |
| sl1 | NULL, | -- Recurs in every slot |

| sl2 | INTEGER (0..1), | |
|---|---|---|
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639) | |
| } | | OPTIONAL, -- Need M |
| resource | PUCCH-ResourceId | OPTIONAL |

-- Need M
}

For the configured PUCCH resource, a transmission period and an offset may be configured through a periodicity AndOffset parameter of Table 29. If there is UL data to be transmitted by the terminal at a time point corresponding to the configured period and offset, a corresponding PUCCH resource may be transmitted and otherwise, the corresponding PUCCH resource may not be transmitted.

In the case of CSI transmission, a PUCCH resource to transmit a semi-persistent or periodic CSI report through a PUCCH may be configured in a pucch-CSI-ResourceList parameter as shown in Table 30. The pucch-CSI-ResourceList parameter may include a list of PUCCH resources BWP-wise for a cell or a CC to transmit the corresponding CSI report. The PUCCH resource may be a resource belonging to the PUCCH format 2, the PUCCH format 3, or the PUCCH format 4.

TABLE 30

| CSI-ReportConfig ::= | SEQUENCE { | |
|---|---|---|
| reportConfigId | CSI-ReportConfigId, | |
| carrier | ServCellIndex | OPTIONAL, -- Need S |

| resourcesForChannelMeasurement | CSI-ResourceConfigId, | |
|---|---|---|
| csi-IM-ResourcesForInterference | CSI-ResourceConfigId | OPTIONAL, -- Need |

R

| | | |
|---|---|---|
| nzp-CSI-RS-ResourcesForInterference | CSI-ResourceConfigId | OPTIONAL, -- |

Need R

| | |
|---|---|
| reportConfigType | CHOICE { |
| periodic | SEQUENCE { |
| reportSlotConfig | CSI-ReportPeriodicityAndOffset, |

| | |
|---|---|
| pucch-CSI-ResourceList | SEQUENCE (SIZE (1..maxNrofBWPs)) OF PUCCH- |

CSI-Resource
},

| | |
|---|---|
| semiPersistentOnPUCCH | SEQUENCE { |

| | |
|---|---|
| reportSlotConfig | CSI-ReportPeriodicityAndOffset, |

| | |
|---|---|
| pucch-CSI-ResourceList | SEQUENCE (SIZE (1..maxNrofBWPs)) OF PUCCH- |

CSI-Resource
},

For PUCCH resource, a transmission period and an offset may be configured through reportSlotConfig of Table 30.

In the case of HARQ-ACK transmission, a resource set of a PUCCH resource to be transmitted according to the payload of UCI including the HARQ-ACK may be selected first. In other words, a PUCCH resource set having a minimum payload no less than the UCI payload may be selected. Next, a PUCCH resource in the PUCCH resource set may be selected through a PUCCH resource indicator (PRI) in DCI that schedules a TB corresponding to the HARQ-ACK, and the PRI may be a PUCCH resource indicator specified in Table 6 or Table 7. The relationship between the PRI and the PUCCH resource selected by the PUCCH resource set may be as in Table 31 shown below.

TABLE 31

| PUCCH resource | |
|---|---|
| indicator | PUCCH resource |
| ‘000’ | 1st PUCCH resource provided by pucch-ResourceId |
| | obtained from the 1st value of resourceList |
| ‘001’ | 2nd PUCCH resource provided by pucch-ResourceId |
| | obtained from the 2nd value of resourceList |
| ‘010' | 3rd PUCCH resource provided by pucch-ResourceId |
| | obtained from the 3rd value of resourceList |
| ‘011' | 4th PUCCH resource provided by pucch-ResourceId |
| | obtained from the 4th value of resourceList |
| ‘100' | 5th PUCCH resource provided by pucch-ResourceId |
| | obtained from the 5th value of resourceList |
| ‘101’ | 6th PUCCH resource provided by pucch-ResourceId |
| | obtained from the 6th value of resourceList |
| ‘110’ | 7th PUCCH resource provided by pucch-ResourceId |
| | obtained from the 7th value of resourceList |
| ‘111’ | 8th PUCCH resource provided by pucch-ResourceId |
| | obtained from the 8th value of resourceList |

If the number of PUCCH resources in the selected PUCCH resource set is greater than 8, the PUCCH resource may be selected by Equation 2.

$${r}_{PUCCH} = \qquad [ Equation 2 ]$$

$$\{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + \\ {R}_{PUCCH} mod 8\end{matrix} & if {Δ}_{PRI} \geq {R}_{PUCCH} mod 8\end{matrix} \}$$

In Equation 2, r_{PUCCH} may denote an index of a selected PUCCH resource in a PUCCH resource set, R_{PUCCH} may denote the number of PUCCH resources belonging to the PUCCH resource set, Δ_{pRI} may denote a PRI value, N_{CCE,p} may denote the total number of CCEs of a CORESET p to which reception DCI belongs, and n_{CCE,p} may denote a first CCE index for the reception DCI.

A time point when the corresponding PUCCH resource is transmitted may be a K₁ slot after from the TB transmission corresponding to the HARQ-ACK. A candidate of a K₁ value may be configured via an higher layer and more specifically, may be set to a dl-DataToUL-ACK parameter in PUCCH-Config specified in Table 21. A K₁ value of the candidates may be selected by a PDSCH-to-HARQ feedback timing indicator in the DCI that schedules a TB and the value may be specified in Table 5 or Table 6. In addition, the unit of the K₁ value may be a slot unit or a sub-slot unit. In this case, the sub-slot may be a unit of length less than a slot, and one or a plurality of symbols may constitute one sub-slot.

In a 5G mobile communication service, an additional coverage expansion technique is adopted compared to an LTE communication service. However, in the actual 5G mobile communication service, a TDD system that is suitable for a service with a generally high UL traffic proportion may be used. In addition, as a center frequency increases to increase a frequency band, the coverage of the base station and the terminal may decrease, and thereby, the coverage enhancement may be a core requirement for the 5G mobile communication service. In particular, because transmission power of the terminal is generally lower than transmission power of the BS and a proportion of DL is higher than that of UL in the time domain to support a service having a higher DL traffic portion, the coverage enhancement of a UL channel may be the core requirement of the 5G mobile communication service. For a method of physically enhancing coverage of a UL channel of a terminal and a base station, methods of increasing a time resource of a UL channel, decreasing a center frequency, and increasing the transmission power of a terminal may exist. However, changing a frequency may be limited since a frequency band is determined for each network operator. In addition, since the maximum transmission power of the terminal is determined by regulations to reduce interference, increasing the maximum transmission power of the terminal may be limited to enhance the coverage.

Therefore, to enhance the coverage of the base station and the terminal, the resources of UL and DL in the time domain may be divided according to the traffic ratio of UL and DL as in the time division duplex (TDD) system, and the resources of UL and DL in a frequency domain may also be divided as a frequency domain division duplex (FDD) system. In an embodiment, a system that may flexibly divide the UL resource and the DL resource in the time domain and the frequency domain may be referred to as a cross-division duplex (XDD) system, a flexible TDD system, a hybrid TDD system, a TDD-FDD system, and a hybrid TDD-FDD system. For ease of description, the disclosure describes it as the XDD system. According to an embodiment, in XDD, X may be time or frequency.

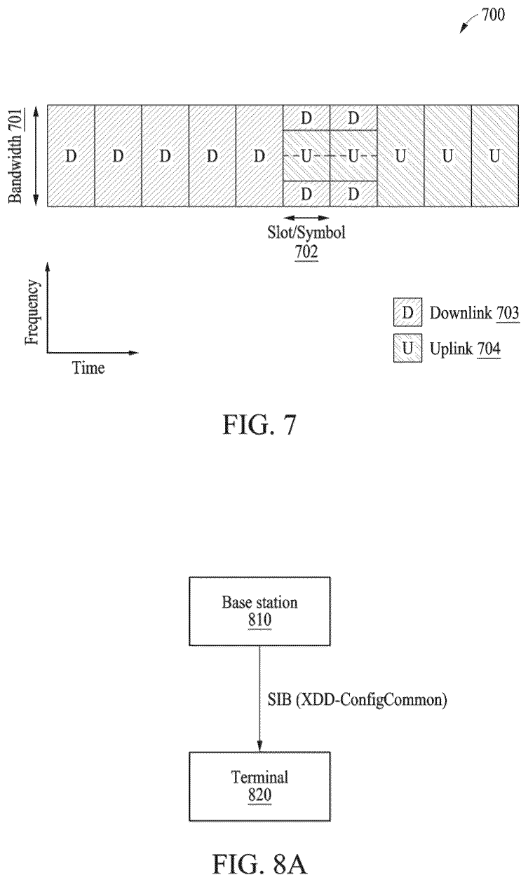

FIG. 7 is a diagram of an example of an uplink-downlink resource configuration of a cross-division duplex (XDD) system according to an embodiment.

FIG. 7 illustrates an example of a UL-DL resource configuration 700 that may be allocated by an XDD system for a frequency band 701. For example, the frequency band 701 may be a unit defined by a frequency domain, such as a system bandwidth, a component carrier, or a BWP. However, the example is not limited thereto, and the frequency band 701 may be a band having an arbitrary size that may be defined or set for the XDD system operation. As shown in FIG. 7, in the XDD system, a DL resource 703 and a UL resource 704 may be simultaneously allocated from one slot or a symbol 702 of the frequency band 701. Hereinafter, the description provided based on the slot unit may be identically applied to the symbol unit-based XDD system. As an example of the method of allocating the DL resource 703 and the UL resource 704 by one slot or the symbol 702 of the frequency band 701, a frequency resource having a predetermined size may be allocated to the DL resource 703 or the UL resource 704 based on a center frequency of the frequency band 701 in the one slot or the symbol 702, and a remaining frequency resource may be allocated to the UL resource 704 or the DL resource 703. Alternatively, as another example of the method of simultaneously allocating the DL resource 703 and the UL resource 704 by the one slot or the symbol 702 of the frequency band 701, a resource of a low-frequency band having a predetermined size in the one slot or the symbol 702 may be allocated to the DL resource 703 or the UL resource 704, and a resource of a high-frequency band excluding the predetermined size may be allocated to the UL resource 704 and the DL resource 703. However, this is an example and does not limit the disclosure. Other than the example described above, the DL resource 703 and the UL resource 704 may be allocated in an arbitrary frequency band in one slot or the symbol 702. In addition, a guard band may be allocated between the DL resource, the UL resource 703, and the UL resource 704. A guard band 704 may be allocated to reduce interference applied to a UL channel or signal reception by out-of-band emission occurring when the base station transmits a DL channel or a signal in the DL resource 703. Hereinafter, unless specifically defined in the disclosure, the “XDD configuration” may be the UL-DL resource configuration 700 of the XDD system.

The XDD configuration may be broadcasted through an SIB, may be configured through RRC signaling or higher layer signaling, or may be configured through MAC CE or DCI, or a combination thereof. In an embodiment, the XDD configuration may be configured to indicate the time or frequency resource used as the UL resource and the DL resource for the XDD system by each cell in a similar method to TDD UL-DL configuration. In an embodiment, the XDD configuration may be configured based on XDD BWP configuration information as a separate XDD BWP is defined for the XDD system or may be configured by configuring a portion of a slot or a symbol of DL BWP configuration or UL BWP configuration to the XDD and using as an XDD slot or a symbol in which both UL and DL resources exist. Depending on the configuration method, the XDD configuration may be configured with a corresponding PUCCH resource or may not have a corresponding PUCCH resource. Accordingly, hereinafter, when a PUCCH resource configuration corresponding to the XDD configuration exists, the PUCCH resource may be construed as a resource based on the corresponding PUCCH resource configuration. On the other hand, if there is no PUCCH resource configuration corresponding to the XDD configuration, the PUCCH resource may be determined based on PUCCH resource configuration that is configured for an initial UL BWP, may be determined based on configured PUCCH resource configuration that is configured for a most recently activated UL BWP, may be determined based on PUCCH resource configuration separately defined for the XDD system, or may be determined based on PUCCH resource configuration of a default BWP that is separately defined or configured for the XDD system.

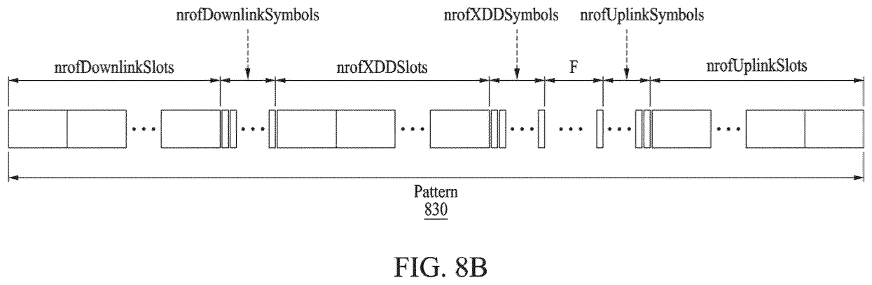

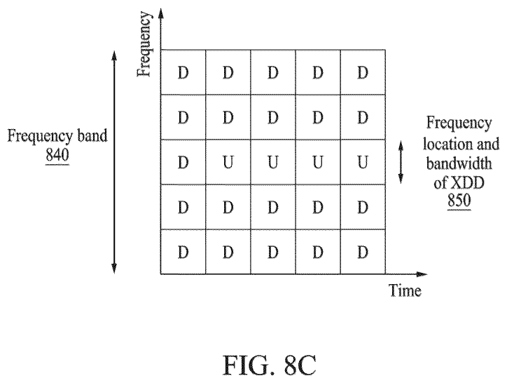

FIGS. 8A to 10B are diagrams of examples of TDD-based XDD configurations according to an embodiment.

In the example shown in FIG. 8A, a terminal 820 may receive XDD common configuration information from a base station 810 through an SIB. The XDD common configuration information may include information in Table 32 shown below.

TABLE 32

| | |
|---|---|
| XDD-ConfigCommon ::= | SEQUENCE { |

| | |
|---|---|
| referenceSubcarrierSpacing | SubcarrierSpacing, |

| pattern1 | XDD-Pattern, | |
|---|---|---|
| pattern2 | XDD-Pattern | OPTIONAL, -- Need R |

...
}

| | |
|---|---|
| XDD-Pattern ::= | SEQUENCE { |

| | |
|---|---|
| XDD-TransmissionPeriodicity | ENUMERATED {ms0p5, ms0p625, ms1, ms1p25, ms2, |

ms2p5, ms5, ms10},

| | |
|---|---|
| nrofDownlinkSlots | INTEGER (0..maxNrofSlots), |

| | |
|---|---|
| nrofDownlinkSymbols | INTEGER (0..maxNrofSymbols-1), |

| | |
|---|---|
| nrofXDDSlots | INTEGER (0..maxNrofSlots), |
| nrofXDDSymbols | INTEGER (0..maxNrofSymbols-1), |

| | |
|---|---|
| locationAndBandwidthforXDD | INTEGER (0..maxNrofRIV), |
| Centerfrequency position | ENUMERATED {True} |

| | |
|---|---|
| nrofUplinkSlots | INTEGER (0..maxNrofSlots), |
| nrofUplinkSymbols | INTEGER (0..maxNrofSymbols-1), |

}

XDD-ConfigCommon of Table 32 shown above may denote the XDD common configuration information and may include reference SubcarrierSpacing (SCS), a pattern 1, and a pattern 2. The pattern 2 may be a pattern that appears after the pattern 1 is terminated. An XDD-pattern may be configured for each of the pattern 1 and the pattern 2.

The XDD-pattern of Table 32 shown above may include a period in which the pattern continues (XDD-TransmissionPeriodicity), the number of consecutive DL slots (nrofDownlinkSlots), the number of consecutive DL symbols (nrofDownlinkSymbols), the number of consecutive XDD slots (nrofXDDSlots), the number of consecutive XDD symbols (nrofXDDSymbols), a frequency location and bandwidth of the XDD (locationAndBandwidthforXDD), a parameter (Centerfrequencyposition) indicating whether locationAndBandwidthforXDD needs to be interpreted based on a center frequency of the frequency band, the number of consecutive UL slots (nrofUplinkSlots), and the number of consecutive UL symbols (nrofUplinkSymbols).

To the XDD-TransmissionPeriodicity, for example, 0.5 ms, 0.625 ms, 1 ms, 1.25 ms, 2 ms, 2.5 ms, 5 ms, or 10 ms may be set.

According to an embodiment, as shown in FIG. 8B, the number of consecutive DL slots from the start of a pattern 830 may be configured for nrofDownlinkSlots, and the number of consecutive DL symbols after a last DL slot of the consecutive DL slots may be configured for nrofDownlinkSymbols. The number of consecutive XDD slots after the last DL symbol of the consecutive DL symbols may be configured for nrofXDDSlots, and the number of XDD symbols after the last XDD slot of the consecutive XDD slots may be configured for nrofXDDSymbols. The number of inversely consecutive UL slots from the end of the pattern 830 may be configured for nrofUplinkSlots, and the number of consecutive UL symbols previous to the first slot of the consecutive UL slots may be configured for nrofUplinkSymbols.

In FIG. 8B, F may denote a flexible symbol.

According to an embodiment, the Centerfrequency position may be set to true or false. To locationAndBandwidthforXDD, information showing a frequency location and bandwidth of the XDD may be. For example, information showing a frequency location and bandwidth of the XDD may be set to locationAndBandwidthforXDD according to a bitmap scheme or an RIV scheme. In the example of FIG. 8C, the Centerfrequency position may be set to true and 0 may be set to locationAndBandwidthforXDD. The terminal 820 may identify that a frequency location and bandwidth 0th away from a center frequency location of a frequency band 840 correspond to the frequency location and bandwidth 850 of the XDD. The Centerfrequency position may be set to false or nothing may be set to the Centerfrequency position. In addition, 0 may be set to locationAndBandwidthforXDD. In this case, the terminal 820 may identify that the 0th frequency location and bandwidth of the frequency band 840 correspond to the frequency location and bandwidth of the XDD.

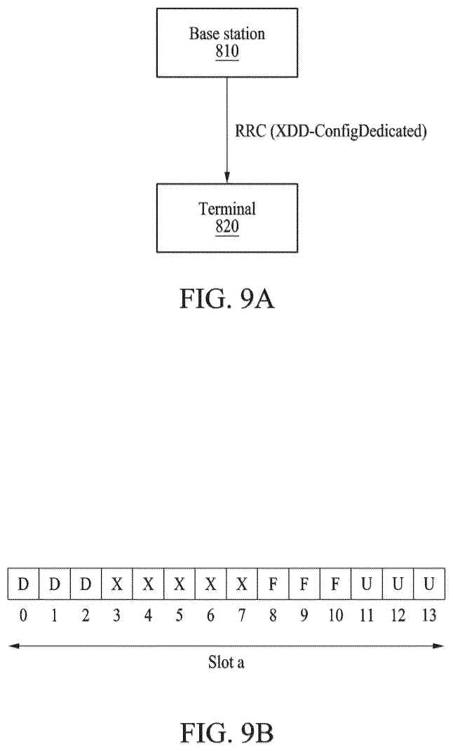

UE-specific XDD configuration is described with reference to FIGS. 9A and 9B.

In the example of FIG. 9A, the terminal 820 may receive XDD-dedicated configuration information from the base station 810 through dedicated higher layer signaling (e.g., RRC signaling). The XDD-dedicated configuration information may include, for example, the information in Table 33 shown below.

TABLE 33

| | |
|---|---|
| XDD-ConfigDedicated ::= | SEQUENCE { |

| | |
|---|---|
| slotSpecificConfigurationsToAddModList | SEQUENCE (SIZE (1..maxNrofSlots)) OF |

XDD-SlotConfig OPTIONAL, -- Need N

| | |
|---|---|
| slotSpecificConfigurationsToreleaseList | SEQUENCE (SIZE (1..maxNrofSlots)) OF XDD |

-SlotIndex OPTIONAL, -- Need N
...
}

| | |
|---|---|
| XDD-SlotConfig ::= | SEQUENCE { |
| slotIndex | XDD-SlotIndex, |

| | |
|---|---|
| locationAndBandwidthforXDD | INTEGER (0..maxNrofRIV), |

| | |
|---|---|
| Centerfrequency position | ENUMERATED {True} |
| symbols | CHOICE { |
| allDownlink | NULL, |
| allUplink | NULL, |
| explicit | SEQUENCE { |

| | |
|---|---|
| nrofDownlinkSymbols | INTEGER (1..maxNrofSymbols-1) |

OPTIONAL, -- Need S

| | |
|---|---|
| nrofXDDSymbols | INTEGER (1..maxNrofSymbols-1) |

OPTIONAL, -- Need S

| | |
|---|---|
| nrofUplinkSymbols | INTEGER (1..maxNrofSymbols-1) |

```
OPTIONAL -- Need S
    }
  }
}
```

| | |
|---|---|
| XDD-SlotIndex ::= | INTEGER (0..maxNrofSlots-1) |

XDD-ConfigDedicated of Table 33 shown above may represent the XDD-dedicated configuration information. XDD-ConfigDedicated may include slotSpecificConfigurationsToAddModList, and a list of XDD slot configurations (XDD-SlotConfig) may be set to slotSpecificConfigurationsToAddModList.

XDD-SlotConfig may include a slot index (slotIndex), locationAndBandwidthforXDD, and Centerfrequency position. To slotIndex, an identifier of the slot may be set. For example, the base station 810 may set an identifier of a slot to slotIndex to set to an XDD slot. The descriptions provided with reference to FIGS. 8A to 8C may apply to the descriptions of locationAndBandwidthforXDD and Centerfrequency position.

XDD-SlotConfig may include the number of consecutive DL symbols (nrofDownlinkSymbols), the number of consecutive XDD symbols (nrofXDDSymbols), and the number of consecutive UL symbols (nrofUplinkSymbols).

According to an embodiment, as shown in FIG. 9B, an identifier of a slot a may be set to slotIndex, information on the frequency location and bandwidth of the XDD may be set to locationAndBandwidthforXDD, and true or false may be set to Centerfrequency position.

According to an embodiment, the number (e.g., 3) of consecutive DL symbols from the start of the slot a may be set to nrofDownlinkSymbols, the number (e.g., 5) of consecutive XDd symbols after the last DL symbol (the second symbol) may be set to nrofXDDSymbols, and the number (e.g., 3) of inversely consecutive UL symbols from the end of the slot a may be set to nrofUplinkSymbols. According to another embodiment, the total number (e.g., 8) of the DL symbols and the XDD symbols may be set to nrofDownlinkSymbols, and the number (e.g., 5) of the XDD symbols may be set to nrofXDDSymbols. In this case, the terminal 820 may recognize that inversely consecutive five symbols from a seventh symbol are XDD symbols through nrofDownlinkSymbols and nrofXDDSymbols, and may recognize that the first three symbols from the start of the slot a are DL symbols. The number (e.g., 3) of inversely consecutive UL symbols from the end of the slot a may be set to nrofUplinkSymbols.

According to an embodiment, the base station 810 may configure a UE-specific XDD slot (e.g., the slot a of FIG. 9B) to the terminal 820 by transmitting the XDD-dedicated configuration information to the terminal 820.

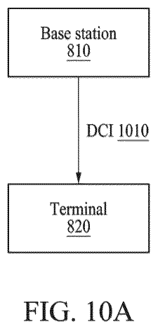

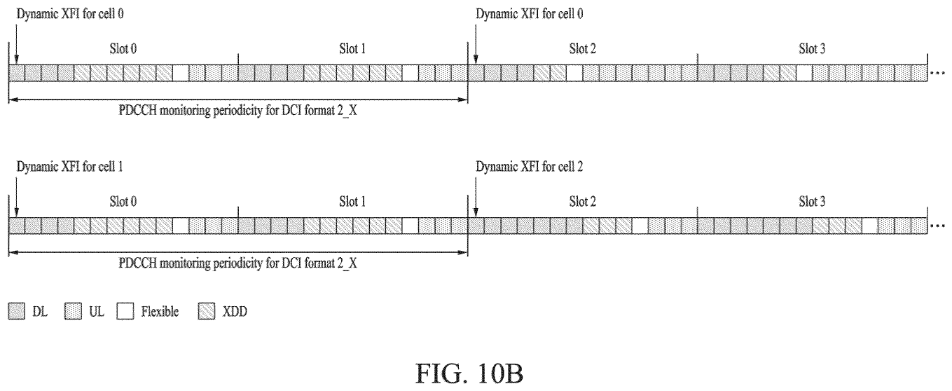

The dynamic XDD configuration is described with reference to FIGS. 10A and 10B.

In the example of FIG. 10A, the terminal 820 may receive DCI 1010 from the base station 810. The DCI 1010 may be scrambled by an SFI-RNTI. The DCI 1010 may be a PDCCH DCI format 2_0, but is not limited thereto.

According to an embodiment, the DCI 1010 may include, for example, an SFI set to one of formats n−x to n−x+a of Table 34 shown below.

TABLE 34

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0~55 | . . . | | | | | | | | | | | | | |
| . . . | . . . | | | | | | | | | | | | | |
| n − x | D | D | D | D | D | D | D | D | D | D | D | D | D | X |
| n − x + 1 | U | U | U | U | U | U | U | U | U | U | U | U | U | X |
| n − x + 2 | F | F | F | F | F | F | F | F | F | F | F | F | F | X |
| . . . | . . . | | | | | | | | | | | | | |
| n − x + a | D | F | F | F | F | U | U | U | X | X | X | X | X | X |

| | |
|---|---|
| . . . | Reserved |
| 255 | UE determines the slot format for the slot based on XDD-ConfigurationCommon, |
| | or XDD -ConfigurationDedicated and, if any, on detected DCI formats |

In [Table 34] shown above, formats 0 to 55 may correspond to the formats 0 to 55 of Table 21 shown above.

The formats n−x to n−x+a may indicate an XDD slot and may be expressed by an XDD slot format indicator (XFI).

According to an embodiment, the base station 810 may transmit SFI entries (e.g., the formats n−x to n−x+a) among the SFI entries (formats 0 to n−x+a) of Table 34 shown above to the terminal 820 through RRC or SIB.

According to an embodiment, the base station 810 may set a valid duration (e.g., PDCCH monitoring periodicity) of the XDD configuration that is dynamically set, and when the set valid duration has elapsed, the base station 810 may transmit the SFI (or an XFI) to a terminal 802 (or a cell). For example, the base station 810 may set a parameter (e.g., the parameter of Table 19 shown above) for a search space for a PDCCH to the terminal 820 through higher layer signaling. In this case, a PDCCH monitoring period may be set. The base station 820 may determine or set the PDCCH monitoring period to be the valid duration of the dynamically set XDD configuration. When the valid duration has elapsed, the base station 810 may transmit an SFI to a cell.

In the example of FIG. 10B, the base station 810 may transmit the same XFI to a cell 0 and a cell 1 from a slot 0. In the example of FIG. 10B, the valid duration may be two slots and the cells 0 and 1 may configure a slot according to a slot format (in other words, XDD configuration) indicated by the received XFI.

The valid duration may elapse and in the slot 2, the base station 810 may transmit an XFI to the cells 0 and 1. In this case, the base station 810 may transmit different XFIs to the cells 0 and 1.

The cells 0 and 1 may each configure a slot according to a slot format indicated by the received XFI. As shown in FIG. 10B, the configuration of the slot 2 of the cell 0 may be different from the configuration of the slot 2 of the cell 2, and similarly, the configuration of the slot 3 of the cell 0 may be different from the configuration of the slot 3 of the cell 1.

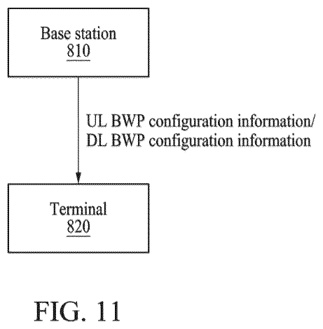

FIG. 11 is a diagram illustrating examples of BWP-based XDD configurations according to an embodiment.

In the example of FIG. 11, the terminal 820 may receive DL BWP configuration information and/or UL BWP configuration information from the base station 810.

In an embodiment, the DL BWP configuration information may include, for example, the information in Table 35 shown below.

TABLE 35

| | |
|---|---|
| BWP-Downlink ::= | SEQUENCE { |
| bwp-Id | BWP-Id, |
| bwp-Id for UL | BWP-Id, |
| bwp-Common | BWP-DownlinkCommon OPTIONAL, -- Cond SetupOtherBWP |
| bwp-Dedicated | BWP-DownlinkDedicated |

| | |
|---|---|
| BWP-DownlinkCommon ::= | SEQUENCE { |

| | |
|---|---|
| genericParameters | BWP, |

| | |
|---|---|
| pdcch-ConfigCommon | SetupRelease { PDSCH-ConfigCommon } |

OPTIONAL, -- Need M

| | |
|---|---|
| pdsch-ConfigCommon | SetupRelease { PDSCH-ConfigCommon } |

OPTIONAL, -- Need M

| | |
|---|---|
| BWP ::= | SEQUENCE { |
| XDD | ENUMERATED { True } |

| | |
|---|---|
| locationAndBandwidth | INTEGER (0..37949), |

| | |
|---|---|
| subcarrierSpacing | SubcarrierSpacing, |
| cyclicPrefix | ENUMERATED { extended } OPTIONAL -- Need R |

BWP-Downlink of Table 35 shown above may represent information to configure XDD based on a DL BWP. BWP-Downlink may include an ID (bwp-Id) of the DL BWP, a BWP ID (bwp-Id for UL) for UL, information (bwp-Common) to configure a common parameter of the DL BWP, and information (bwp-Dedicated) to configure a dedicated parameter of the DL BWP. The configured UL BWP through Table 35 shown above may be an UL BWP for XDD, and thereby, may be referred to as an XDD UL BWP.

The BWP of Table 35 shown above may include a parameter (XDD) to indicate that the DL BWP configuration information is for the configuration of the XDD, information (locationAndBandwidth) on a frequency location and bandwidth of the UL BWP (or the XDD UL BWP), subcarrierSpacing, and cyclicPrefix. According to an embodiment, the terminal 820 may identify the frequency location and bandwidth of the XDD UL BWP through locationAndBandwidth. For example, the terminal 820 may assume that center frequencies of the DL BWP and the XDD UL BWP activated in the same slot are the same. The terminal 820 may identify that a frequency location and bandwidth apart from the center frequency location of the activated DL BWP by a configuration value of locationAndBandwidth correspond to the XDD UL BWP. For example, when 1 is set to locationAndBandwidth, the terminal 820 may identify that the frequency location and bandwidth apart from the center frequency of the activated DL BWP by 1 correspond to the XDD UL BWP.

According to an embodiment, the parameter (XDD) may be omitted from the BWP in the table 35 shown above.

According to an embodiment, Centerfrequency position may be further included in the BWP of Table 35 shown above. The Centerfrequency position may represent whether locationAndBandwidth needs to be interpreted based on the center frequency location of the DL BWP.

According to an embodiment, when an ID is set to “bwp-Id for UL” in the DL BWP configuration information received from the base station 810, the terminal 820 may recognize that a UL of the ID set to “bwp-Id for UL” is an XDD UL. In other words, when an ID is set to “bwp-Id for UL” in the DL BWP configuration information received from the base station 810, the terminal 820 may recognize that the received DL BWP configuration information is for the XDD configuration. According to another embodiment, when an ID is not set to “bwp-Id for UL” in the DL BWP configuration information received from the base station 810 or “bwp-Id for UL” is omitted, the terminal 820 may recognize that the received DL BWP configuration information is for the configuration of the DL BWP.

According to an embodiment, the UL BWP configuration information may include, for example, information in Table 36 shown below.

TABLE 36

| | |
|---|---|
| BWP-Uplink ::= | SEQUENCE { |
| bwp-Id | BWP-Id, |
| bwp-Id for DL | BWP-Id |
| bwp-Common | BWP-UplinkCommon OPTIONAL, -- Cond SetupOtherBWP |
| bwp-Dedicated | BWP-UplinkDedicated OPTIONAL, -- Cond SetupOtherBWP |

| | |
|---|---|
| BWP-UplinkCommon ::= | SEQUENCE { |

| | |
|---|---|
| genericParameters | BWP, |

| | |
|---|---|
| rach-ConfigCommon | SetupRelease { RACH-ConfigCommon } |

OPTIONAL, -- Need M

| | |
|---|---|
| pusch-ConfigCommon | SetupRelease { PUSCH-ConfigCommon } |

OPTIONAL, -- Need M

| | |
|---|---|
| pucch-ConfigCommon | SetupRelease { PUCCH-ConfigCommon } |

OPTIONAL, -- Need M

| | |
|---|---|
| BWP ::= | SEQUENCE { |
| XDD | ENUMERATED { True } OPTIONAL -- Need R |

| | |
|---|---|
| locationAndBandwidth | INTEGER (0..37949), |

| | |
|---|---|
| subcarrierSpacing | SubcarrierSpacing, |
| cyclicPrefix | ENUMERATED { extended } OPTIONAL -- Need R |

BWP-Uplink of [Table 36] may represent information to configure XDD based on a UL BWP. BWP-Uplink may include an ID (bwp-Id) of the UL BWP, a BWP ID (bwp-Id for DL) for the DL, information (bwp-Common) to set a common parameter of the UL BWP, and information (bwp-Dedicated) to set a dedicated parameter of the UL BWP. The DL BWP configured through Table 36 shown above may be a DL BWP for XDD, and thereby, may be referred to as an XDD DL BWP.

The BWP of Table 36 may include a parameter (XDD) to indicate that the UL BWP configuration information is for the configuration of the XDD, information (locationAndBandwidth) on a frequency location and bandwidth of the DL BWP (or the XDD DL BWP), subcarrierSpacing, and cyclicPrefix. According to an embodiment, the terminal 820 may identify the frequency location and bandwidth of the XDD DL BWP through locationAndBandwidth. For example, the terminal 820 may assume that center frequencies of the UL BWP and the XDD DL BWP activated in the same slot are the same. The terminal 820 may identify that a frequency location and bandwidth apart from the center frequency location of the activated UL BWP by a configuration value of locationAndBandwidth correspond to the XDD DL BWP.

According to an embodiment, when an ID is set to “bwp-Id for DL” in the UL BWP configuration information received from the base station 810, the terminal 820 may recognize that a DL of the ID set to “bwp-Id for DL” is an XDD DL. In other words, when an ID is set to “bwp-Id for DL” in the UL BWP configuration information received from the base station 810, the terminal 820 may recognize that the received UL BWP configuration information is for the XDD configuration. According to another embodiment, when an ID is not set to “bwp-Id for DL” in the UL BWP configuration information received from the base station 810 or “bwp-Id for DL” is omitted, the terminal 820 may recognize that the received UL BWP configuration information is for the configuration of the UL BWP.

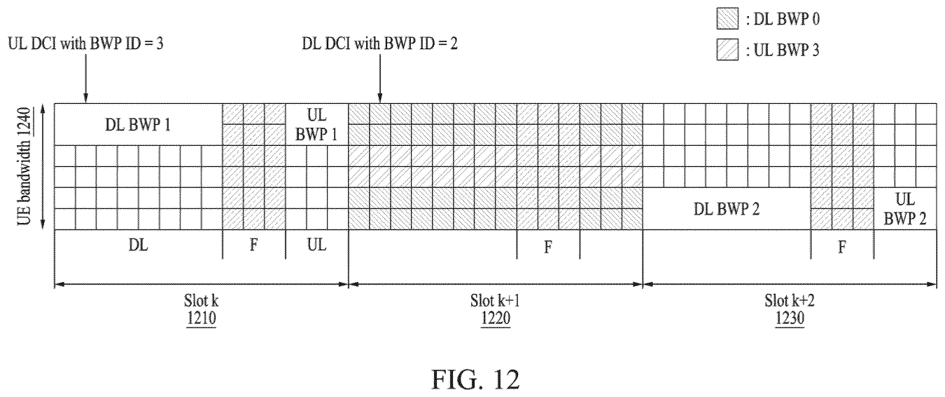

FIGS. 12 to 16 are diagrams illustrating BWP switching according to an embodiment.

BWP switching when a DL BWP is linked to an XDD UL BWP is described with reference to FIG. 12.

In the example of FIG. 12, a plurality of DL BWPs (e.g., a DL BWP 0, a DL BWP 1, and a DL BWP 2) and a plurality of UL BWPs (e.g., a UL BWP 0, a UL BWP1, a UL BWP 2, and a UL BWP 3) may be set to the terminal 820. The DL BWP 0 may be an initial DL BWP (or a default DL BWP), and the UL BWP 0 may be an initial UL BWP (or a default UL BWP). In the example of FIG. 12, the DL BWP 0 and the UL BWP 0 may have a UE bandwidth 1240.

In an embodiment, a DL BWP and a UL BWP having the same BWP ID and center frequency may be linked to each other. For example, an ID of the DL BWP 0 and an ID of the UL BWP 0 may be the same as 0, and a center frequency of the DL BWP 0 and a center frequency of the UL BWP 0 may be the same. The DL BWP 0 and the UL BWP 0 may be linked to each other. Similarly, the DL BWP 1 and the UL BWP may be linked to each other, and the DL BWP 2 and the UL BWP 2 may be linked to each other.

In the example of FIG. 12, the UL BWP 3 may correspond to an XDD UL BWP. In other words, the UL BWP 3 may be a UL BWP for XDD. For example, the terminal 820 may receive the DL BWP configuration information of Table 35 shown above from the base station 810. The ID of the UL BWP 3 may be set to “bwp-Id for UL” in the received DL BWP configuration information may be set. In this case, the terminal 820 may recognize that the UL BWP 3 is for a UL BWP for XDD.

In an embodiment, the UL BWP 3 may be linked to the initial DL BWP (or the default DL BWP). In another embodiment, the UL BWP 3 may be linked to a DL BWP according to a hardcoded scheme. For example, according to the hardcoded scheme, it may be determined to link a DL BWP having an ID of n to a UL BWP having an ID of (n+a). When a is 2, the UL BWP 3 may be linked to the DL BWP 1. In another embodiment, the terminal 820 may receive which DL BWP is linked to the XDD UL BWP through an SIB or RRC from the base station 810.

In a slot k 1210, the DL BWP 1 and the UL BWP 1 may be activated.

In the slot k 1210, the terminal 820 may perform DL communication and/or UL communication with the base station 810 according to a TDD scheme.

In the slot k 1210, the terminal 820 may receive UL DCI from the base station 810. The received UL DCI may include a BPI, and the BPI may indicate the UL BWP 3. In other words, the base station 810 may instruct the terminal 820 to perform a BWP change from the UL BWP 1 to the UL BWP 3 using the BPI. By considering latency T_{BWP} required to change the BWP, the BWP change may be completed in the slot k 1210. The UL BWP 3 (XDD UL BWP) may be activated in a slot k+1 1220. When the UL BWP 3 is linked to the initial DL BWP (or the default DL BWP), the DL BWP 0 may be activated in the slot k+1 1220.

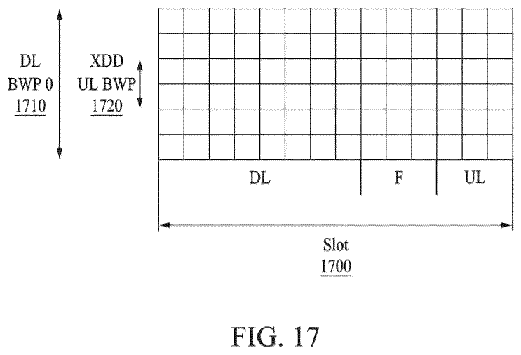

The DL BWP 0 may be the UE bandwidth 1240, and thereby, a portion (a center frequency band) of the DL BWP 0 may overlap the UL BWP 3 in the slot k+1 1220. In this case, according to the priority between a UL signal/channel and a DL signal/channel, a signal/channel of lower priority may be dropped or rate matching may be performed. A related description is provided with reference to FIG. 17.

In the slot k+1 1220, the terminal 820 may perform DL communication with the base station 810 via the DL BWP 0, and may perform UL communication with the base station 810 via the UL BWP 3. One or more symbols of the slot k+1 1220 may simultaneously include a DL resource and a UL resource, and thereby, the slot k+1 1220 may correspond to an XDD slot.

In the slot k+1 1220, the terminal 820 may receive DL DCI from the base station 810. The received DL DCI may include a BPI and the BPI may indicate the DL BWP 2. In other words, the base station 810 may instruct the terminal 820 to perform a BWP change from the DL BWP 0 to the DL BWP 2 using the BPI. By considering latency T_{BWP} required to change the BWP, the BWP change may be completed in the slot k+1 1220. The DL BWP 2 may be activated in a slot k+2 1230, and the UL BWP 2 linked to the DL BWP 2 may be activated.

In the slot k+2 1220, the terminal 820 may perform DL communication and UL communication with the base station 810 according to the TDD scheme.

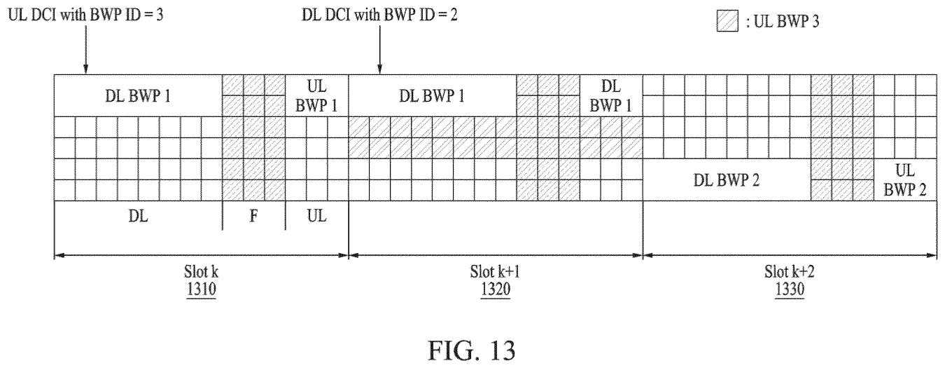

BWP switching when a DL BWP is not linked to an XDD UL BWP is described with reference to FIG. 13. Remaining UL BWPs other than the XDD UL BWP may be linked to a specific DL BWP through the embodiment described with reference to FIG. above.

In the example of FIG. 13, a plurality of DL BWPs (e.g., a DL BWP 0, a DL BWP 1, and a DL BWP 2) and a plurality of UL BWPs (e.g., a UL BWP 0, a UL BWP1, a UL BWP 2, and a UL BWP 3) may be set to the terminal 820. In FIG. 13, the UL BWP 3 may be an XDD UL BWP.

In a slot k 1310, the DL BWP 1 and the UL BWP 1 may be activated.

In the slot k 1310, the terminal 820 may perform DL communication and UL communication with the base station 810 according to the TDD scheme.

In the slot k 1310, the terminal 820 may receive UL DCI from the base station 810. The received UL DCI may include a BPI, and the BPI may indicate the UL BWP 3. By considering latency T_{BWP} required to change the BWP, the BWP change may be completed in the slot k 1310. In a slot k+1 1320, the UL BWP 3 may be activated. In the example of FIG. 13, the UL BWP 3 may not be linked to any DL BWP. The activated DL BWP 1 in the slot k 1310 may be maintained in the slot k+1 1320. In the slot k+1 1320, the UL BWP 3 may be newly activated, and the activation of the DL BWP 1 may be maintained.

In the slot k+1 1320, the terminal 820 may simultaneously perform DL communication and UL communication with the base station 810. The slot k+1 1320 may correspond to an XDD slot.

In the slot k+1 1320, the terminal 820 may receive DL DCI from the base station 810. The received DL DCI may include a BPI and the BPI may indicate the DL BWP 2. By considering latency T_{BWP} required to change the BWP, the BWP change may be completed in the slot k+1 1220. The DL BWP 2 may be activated in a slot k+2 1330, and the UL BWP 2 linked to the DL BWP 2 may be activated.

In the slot k+2 1320, the terminal 820 may perform DL communication and UL communication with the base station 810 according to the TDD scheme.

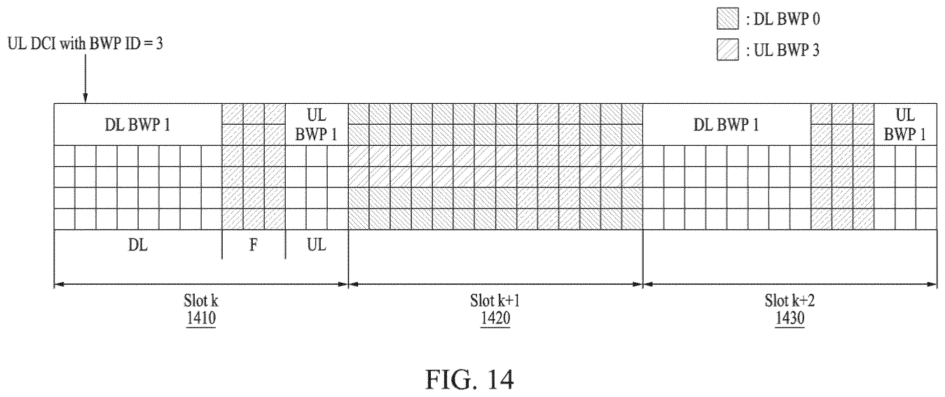

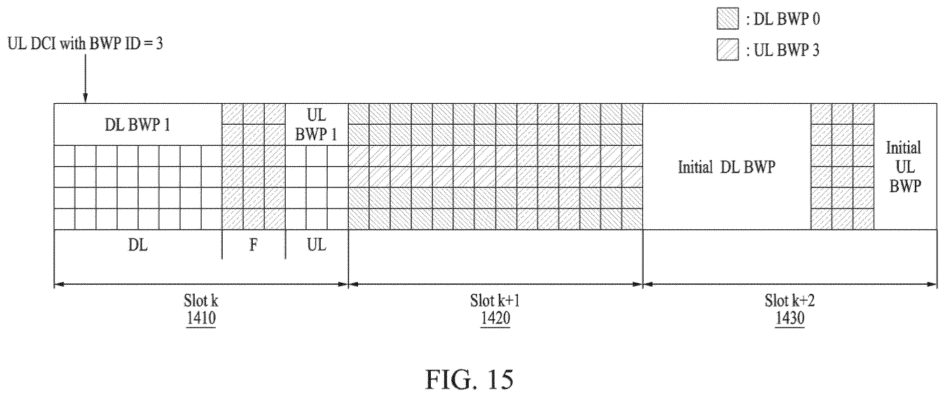

Timer-based BWP switching is described with reference to FIGS. 14 and 15.

In the example of FIG. 14, a plurality of DL BWPs (e.g., a DL BWP 0, a DL BWP 1, and a DL BWP 2) and a plurality of UL BWPs (e.g., a UL BWP 0, a UL BWP1, a UL BWP 2, and a UL BWP 3) may be set to the terminal 820. As described with reference to FIG. 12, the DL BWP 0, the DL BWP 1, and the DL BWP 2 may be linked to the UL BWP 0, the UL BWP 1, and the UL BWP 2, respectively. The UL BWP 3 may be an XDD UL BWP and may be linked to a specific DL BWP according to one of the embodiments described with reference to FIG. 12.

In a slot k 1410, the DL BWP 1 and the UL BWP 1 may be activated.

In the slot k 1410, the terminal 820 may perform DL communication and UL communication with the base station 810 according to the TDD scheme.

In the slot k 1410, the terminal 820 may receive UL DCI from the base station 810. The BPI in the received UL DCI may indicate the UL BWP 3. By considering latency T_{BWP} required to change the BWP, the BWP change may be completed in the slot k 1410. The UL BWP 3 (XDD UL BWP) may be activated in a slot k+1 1420. In the example of FIG. 14, when the UL BWP 3 is linked to the DL BWP 0, in the slot k+1 1420, the DL BWP 0 may be activated.

In the slot k+1 1420, the terminal 820 may simultaneously perform DL communication and UL communication with the base station 810. The slot k+1 1420 may correspond to an XDD slot.

A valid duration of the activated XDD BWP may be set. The valid duration may elapse while the terminal 820 does not receive an instruction for the BWP change from the base station 810.

In an embodiment, when the valid duration of the activated XDD BWP has elapsed, a recently activated DL BWP and a UL BWP before a XDD slot may be activated in a slot after the valid duration. For example, in the example of FIG. 14, the valid duration of the activated XDD BWP may be set to 1 slot through a parameter (e.g., the PDCCH monitoring periodicity) of higher layer signaling. In the slot k+1 1420, the terminal 820 may not receive an instruction for the BWP change from the base station 810, and the slot k+1 1420 may elapse. The elapse of the slot k+1 1420 may correspond to an elapse of a valid duration (1 slot). The most recently activated DL BWP and UL BWP before the XDD slot (e.g., the slot k+1 1420) may be the DL BWP 1 and the UL BWP 1 activated in the slot k 1410. When the valid duration has elapsed, the DL BWP 1 and the UL BWP 1 may be activated in a slot k+2 1430.

In another embodiment, when the valid duration of the activated XDD BWP has elapsed, the initial DL BWP (or the default DL BWP) and the initial UL BWP (or the default UL BWP) may be activated. In the example of FIG. 15, when the valid duration has elapsed, an initial DL BWP 1510 and an initial UL BWP 1520 may be activated in the slot k+2 1430.

In another embodiment, when the valid duration of the activated XDD BWP has elapsed, a preset DL BWP and a UL BWP may be activated. For example, when the valid duration has elapsed, the DL BWP 1 and the UL BWP 2 may be preset to be activated. When the valid duration has elapsed, the DL BWP 1 and the UL BWP 2 may be activated in the slot k+2 1430.

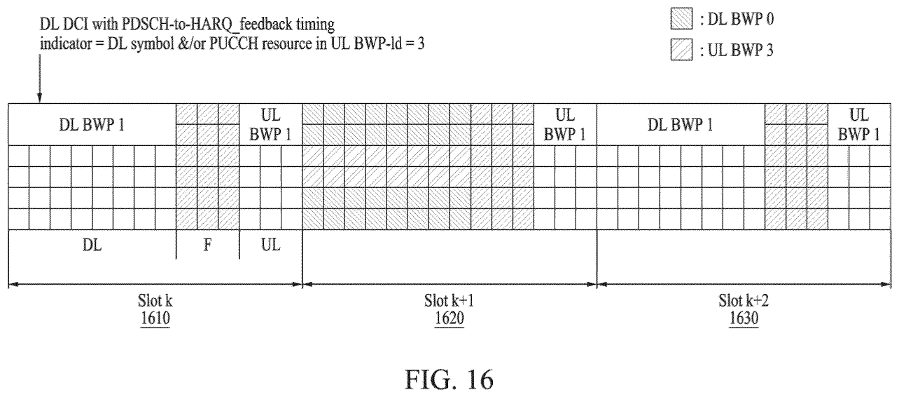

The BWP switching when an event occurs is described with reference to FIG. 16.

In the example of FIG. 15, a plurality of DL BWPs (e.g., the DL BWPs 0, 1, and 2) and a plurality of UL BWPs (e.g., the UL BWPs 0, 1, 2, and 3) may be set to the terminal 820. As described with reference to FIG. 12, the DL BWP 0, the DL BWP 1, and the DL BWP 2 may be linked to the UL BWP 0, the UL BWP 1, and the UL BWP 2, respectively. The UL BWP 3 may be an XDD UL BWP and may be linked to a specific DL BWP according to one of the embodiments described with reference to FIG. 12.

The DL BWP 1 and the UL BWP 1 may be activated in a slot k 1610.

In the slot k 1610, the terminal 820 may receive DL DCI from the base station 810. The received UL DCI may include a PDSCH-to-HARQ_feedback timing indicator, and the PDSCH-to-HARQ_feedback timing indicator may indicate a PUCCH resource and/or a DL symbol of the UL BWP 3. In other words, the terminal 820 may know that a resource to which HARQ ACK/NACK is transmitted for a PDSCH corresponds to the UL BWP 3 through the PDSCH-to-HARQ_feedback timing indicator. By considering latency T_{BWP} required to change the BWP, the BWP change may be completed in the slot k 1610. In this case, the UL BWP 3 may be activated in a slot k+1 1620, and a DL BWP (e.g., the DL BWP 0) linked to the UL BWP 3 may be activated. As another example, the terminal 820 may know whether a resource to which the HARQ ACK/NACK is transmitted for the PDSCH and a resource for transmitting the CSI correspond to the UL BWP 3 through the PDSCH-to-HARQ_feedback timing indicator. When the resource to which the HARQ ACK/NACK is transmitted for the PDSCH and the resource for transmitting the CSI correspond to the UL BWP 3 and it is possible to complete a BWP change in the slot k 1610, the UL BWP 3 may be activated in the slot k+1 1620, and a DL BWP (e.g., the DL BWP 0) linked to the UL BWP 3 may be activated.

According to an embodiment, in the slot k+1 1620, when the terminal 820 transmits PDSCH-to-HARQ feedback (or both the PDSCH-to-HARQ feedback and the CSI) to the base station 810 through the UL BWP 3, the terminal 820 may return to last BWP configuration (e.g., the BWP configuration of a previous slot of the XDD slot). For example, after transmitting the PDSCH-to-HARQ feedback (or both the PDSCH-to-HARQ feedback and the CSI) through the UL BWP 3 in the slot k+1 160, the terminal 820 may configure a remaining symbol period (e.g., last six symbols of the slot k+1 1620) of the slot k+1 1620 according to the last BWP configuration (e.g., the configuration of the last six symbols of the slot k 1610). Accordingly, as the example shown in FIG. 16, the configuration of the last six symbols of the slot k+1 1620 may be the same as the configuration of the last six symbols of the slot k 1610. According to another embodiment, unlike the example of FIG. 16, when the terminal 820 transmits the PDSCH-to-HARQ feedback (or both the PDSCH-to-HARQ feedback and the CSI) through the UL BWP 3 in the slot k+1 1620, the terminal 820 may not return to the last BWP configuration in the remaining symbol period of the slot k+1 1620. In this case, like the slot k+1 1420 of FIGS. 14 and 15, the UL BWP 3 may be activated in the last three symbols of the slot k+1 1620 of FIG. 16, and a DL BWP (e.g., the DL BWP 0) linked to the UP BWP 3 may be activated.

According to an embodiment, as described with reference to FIG. 15, a valid duration of an activated XDD BWP may be set. The valid duration may elapse while the terminal 820 does not receive an instruction for the BWP change from the base station 810. When the valid duration has elapsed, a recently activated DL BWP and a recently activated UL BWP before the XDD slot may be activated in a slot after the valid duration, an initial DL BWP (or a default DL BWP) and an initial UL BWP (or a default UL BWP) may be activated, or a preset DL BWP and a preset UL BWP may be activated. For example, as shown in FIG. 16, the valid duration may be set to 1 slot. In the slot k+1 1620, the terminal 820 may not receive an instruction for the BWP change from the base station 810, and the slot k+1 1620 may elapse. The elapse of the slot k+1 1620 may correspond to an elapse of a valid duration (1 slot). The most recently activated DL BWP and UL BWP before the XDD slot (e.g., the slot k+1 1620) may be the DL BWP 1 and the UL BWP 1 activated in the slot k 1610. When the valid duration has elapsed, the DL BWP 1 and the UL BWP 1 may be activated in the slot k+2 1460.

FIG. 17 is a diagram illustrating a resource overlap according to an embodiment.

Referring to FIG. 17, a DL BWP 0 1710 and an XDD UL BWP 1720 may be set to a slot 1700. The terminal 820 may receive a DL channel (or a DL signal) from the base station 810 through the DL BWP 0 1710. The terminal 820 may transmit a UL channel (or a UL signal) through the XDD UL BWP 1720 to the base station 810.

In the example of FIG. 17, the DL BWP 0 1710 and the XDD UL BWP 1720 may overlap each other. In other words, a resource overlap may occur between the DL BWP 0 1710 and the XDD UL BWP 1720.

When the resource overlap occurs, it may be processed according to priority order between a UL channel/signal and a DL channel/signal. Table 37 shows an example of the priority.

TABLE 37
SS/PBCH on the Pcell
CORESET0/Searchspace0
PDSCH associated with P-RNTI, RA-RNTI or SI-RNTI on the Pcell
PRACH transmission on the PCell
PUCCH transmission with HARQ-ACK information and/or SR or PUSCH
transmission with HARQ-ACK information
PUCCH transmission with CSI or PUSCH transmission with CSI
PDSCH associated with C-RNTI
PUSCH transmission without HARQ-ACK information or CSI
Aperiocdic/Periodic CSI-RS
SRS transmission, with aperiodic SRS having higher priority than
semi-persistent and/or periodic SRS, or PRACH transmission on a
serving cell other than the PCell

In [Table 37], the priority may decrease from top to bottom. The priorities of “SS/PBCH on the Pcell”, “CORESET0/Searchspace0”, and “PDSCH associated with P-RNTI, RA-RNTI, or SI-RNTI on the Pcell” may be the highest, the priority of “PRACH transmission on the PCell” may be the second highest, and the priority of “SRS transmission, with aperiodic SRS having higher priority than semi-persistent and/or periodic SRS, or PRACH transmission on a serving cell other than the PCell” may be the lowest. The priorities of “SS/PBCH on the Pcell”, “CORESET0/Searchspace0”, and “PDSCH associated with P-RNTI, RA-RNTI, or SI-RNTI on the Pcell” may be the same.

According to an embodiment, when a resource overlap (e.g., a resource overlap between the XDD UL BWP 1720 and the DL BWP 0 1710) between a UL resource and a DL resource occurs, the terminal 820 may drop one with a lower priority between a UL channel/signal or a DL channel/signal. For example, the terminal 820 may be scheduled to receive a PDSCH associated with C-RNTI from the base station 810 through the DL BWP 0 1710 in the slot 1700 and may be scheduled to perform PUCCH transmission with CSI through the XDD UL BWP 1720. According to Table 37, the priority of PDSCH associated with C-RNTI may be lower than the priority of PUCCH transmission with CSI. In the slot 1700, the terminal 820 may drop PDSCH associated with C-RNTI and may perform PUCCH transmission with CSI first. The terminal 820 may transmit NACK for PDSCH associated with C-RNTI to the base station 810 according to the drop of PDSCH associated with C-RNTI.

According to an embodiment, when a resource overlap (e.g., a resource overlap between the XDD UL BWP 1720 and the DL BWP 0 1710) between a UL resource and a DL resource occurs, the terminal 820 may perform rate matching on one with a lower priority between a UL channel/signal and a DL channel/signal.

According to another embodiment, when a resource overlap (e.g., a frequency overlap between the XDD UL BWP 1720 and the DL BWP 0 1710) between a UL resource and a DL resource occurs, the terminal 820 may calculate a ratio (e.g., a ratio of an overlapping UL frequency band in the DL BWP or a ratio of an overlapping DL frequency band in the UL BWP) of an overlapping resource. For example, in the example of FIG. 17, an entirety of the XDD UL BWP 1720 may overlap the DL BWP 0 1710, and the terminal 820 may calculate a ratio of the XDD UL BWP 1720 in the DL BWP 0 1710, which is “⅓”. When a calculated ratio exceeds a threshold value, the terminal 820 may drop one with a lower priority between a UL channel/signal and a DL channel/signal. When the calculated ratio is less than or equal to the threshold value, the terminal 820 may perform rate matching on one with the lower priority between the UL channel/signal and the DL channel/signal.

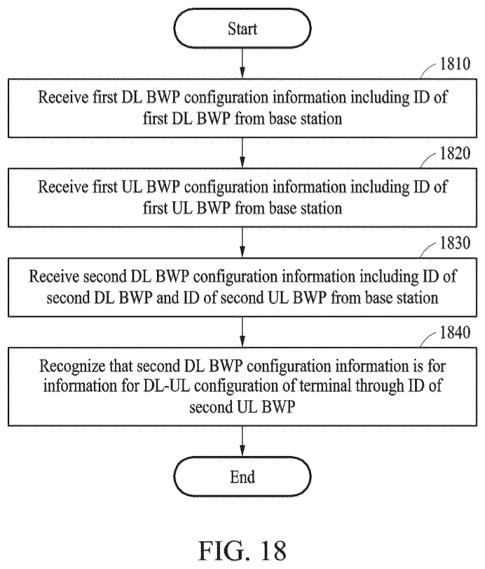

FIG. 18 is a flowchart illustrating an operation method of a terminal according to an embodiment.

Referring to FIG. 18, in operation 1810, the terminal 820 may receive first DL BWP configuration information including an ID of a first DL BWP (e.g., the DL BWP 1 of FIG. 12) from the base station 810.

In operation 1820, the terminal 820 may receive first UL BWP configuration information including an ID of a first UL BWP (e.g., the UL BWP 1 of FIG. 12) from the base station 810.

In operation 1830, the terminal 820 may receive second DL BWP configuration information including an ID of a second DL BWP and an ID of a second UL BWP (e.g., the UL BWP 3 of FIG. 12) from the base station 810.

In operation 1840, the terminal 820 may recognize that the second DL BWP configuration information is information (e.g., XDD configuration information) for DL-UL configuration of the terminal 820 through the ID of the second UL BWP.

The first DL BWP and the first UL BWP may be configured in a first slot (e.g., the slot k 1210 of FIG. 12). In the first slot, the first DL BWP and the first UL BWP may be temporally separated from each other and the terminal 820 may be unable to perform DL communication and UL communication simultaneously with the base station 810. The terminal 820 may be able to perform DL communication and UL communication simultaneously with the base station 810 in a second slot (e.g., the slot k+1 1220 of FIG. 12) based on the second DL BWP configuration information.

According to an embodiment, the terminal 820 may receive UL DCI (e.g., the UL DCI with BWP ID=3 of FIG. 12) from the base station 810 in a first slot (e.g., the slot k 1210 of FIG. 12). When a BWP indicator in the received UL DCI indicates the second UL BWP (e.g., the UL BWP 3 of FIG. 12), the terminal 820 may perform a BWP change from the first UL BWP to the second UL BWP and may perform a BWP change from the first DL BWP to a DL BWP (e.g., the DL BWP 0 of FIG. 12) linked to the second UL BWP. In the second slot (e.g., the slot k+1 1220 of FIG. 12), the second UL BWP and the DL BWP linked with the second UL BWP may be activated.

According to an embodiment, the terminal 820 may receive UL DCI (e.g., the UL DCI with BWP ID=3 of FIG. 13) from the base station 810 in the first slot (e.g., the slot 1310 of FIG. 13). When a BWP indicator in the received UL DCI indicates the second UL BWP (e.g., the UL BWP 3 of FIG. 13), the terminal 820 may perform a BWP change from the first UL BWP to the second UL BWP and may maintain the activated first DL BWP in the first slot. In the second slot (e.g., the slot k+1 1320 of FIG. 13), the second UL BWP and the first DL BWP may be activated.

According to an embodiment, the terminal 820 may receive UL DCI (e.g., the UL DCI with BWP ID=3 of FIG. 14) from the base station 810 in the first slot (e.g., the slot k 1410 of FIG. 14). When a BWP indicator in the received UL DCI indicates the second UL BWP (e.g., the UL BWP 3 of FIG. 14), the terminal 820 may perform a BWP change from the first UL BWP to the second UL BWP and may perform a BWP change from the first DL BWP to a DL BWP (e.g., the DL BWP 0 of FIG. 14) linked to the second UL BWP. When a valid duration of an activated XDD BWP (e.g., the activated second UL BWP) has elapsed, the terminal 820 may perform a BWP change from the second UL BWP to the first UL BWP or an initial UL BWP, and may perform a BWP change from the DL BWP linked to the second UL BWP to the first DL BWP or an initial DL BWP.

According to an embodiment, the terminal 820 may receive DL DCI from the base station 820 in the first slot (e.g., the slot k 1610 of FIG. 16). When a first feedback timing indicator (e.g., the PDSCH-to-HARQ feedback timing indicator of FIG. 16) in the received DL DCI corresponds to the second UL BWP (e.g., a second portion 1602 of FIG. 16), the terminal 820 may perform a BWP change from the first UL BWP to the second UL BWP, and may perform a BWP change from the first DL BWP to the DL BWP linked to the second UL BWP. Depending on the implementation, when both of the first feedback timing indicator in the received DL DCI and a resource that transmits a CSI report correspond to the second UL BWP, the terminal 820 may perform a BWP change from the first UL BWP to the second UL BWP and may perform a BWP change from the first DL BWP to the DL BWP linked to the second UL BWP. When a valid duration of an XDD BWP (e.g., the activated second UL BWP) has elapsed, the terminal 820 may perform a BWP change from the second UL BWP to the first UL BWP or an initial UL BWP, and may perform a BWP change from the second UL BWP and the activated DL BWP to the first DL BWP or an initial DL BWP.

According to an embodiment, when an overlap between an allocated DL frequency resource (e.g., the DL BWP 0 1710 of FIG. 17) and an allocated UL frequency resource (e.g., the XDD UL BWP 1720 of FIG. 17) occurs in the second slot (e.g., the slot 1700 of FIG. 17), the terminal 820 may drop one of DL communication and UL communication having a lower priority or may perform rate matching on one with the lower priority.

According to an embodiment, when overlap between an allocated DL frequency resource (e.g., the DL BWP 0 1710 of FIG. 17) and an allocated UL frequency resource (e.g., the XDD UL BWP 1720 of FIG. 17) occurs in the second slot (e.g., the slot 1700 of FIG. 17), the terminal 820 may calculate a ratio of an overlapping frequency resource (e.g., the ratio described with reference to FIG. 17), and when the calculated ratio exceeds a threshold value, the terminal 820 may drop one of DL communication and UL communication having a lower priority, and when the calculated ratio is less than or equal to a threshold value, the terminal 820 may perform rate matching on one of DL communication and UL communication having a lower priority.

According to an embodiment, the terminal 820 may receive XDD configuration information (e.g., common configuration information, dedicated configuration information, and an SFI) on the configuration of a UL resource and a DL resource from the base station 810. In an XDD slot (or an XDD symbol) based on the received XDD configuration information, the terminal 820 may be able to simultaneously perform DL communication and UL communication with the base station 810.

According to an embodiment, the terminal 820 may receive common configuration information (e.g., XDD-ConfigCommon of Table 32) on the configuration of a UL resource and a DL resource from the base station 810. The received common configuration information may include, for example, the number of DL slots, the number of DL symbols, the number of XDD slots, the number of XDD symbols, the number of UL slots, the number of UL symbols, information on a frequency location of an XDD and a bandwidth, and a parameter (e.g., Center frequency position of Table 32) whether a frequency location of the XDD needs to be interpreted based on a center frequency location of a frequency band allocated to the terminal 820. In the XDD slot or the XDD symbol according to the received first common configuration information, the terminal 820 may simultaneously perform DL communication and UL communication with the base station 810.

According to an embodiment, the terminal 820 may receive dedicated configuration information (e.g., XDD-ConfigDedicated of Table 33) on the configuration of a UL resource and a DL resource from the base station 810. The received dedicated configuration information may include, for example, an index of a slot (e.g., the slot a of FIG. 9B) configured as an XDD slot, and respective numbers of DL symbols, XDD symbols, and UL symbols included in the XDD slot. In the XDD slot (e.g., the slot a of FIG. 9B), the terminal 820 may be able to simultaneously perform DL communication and UL communication with the base station 810.

According to an embodiment, the terminal 820 may receive a first SFI from the base station 810, and may identify that a third slot (e.g., the slot 0 for the cell 0 of FIG. 10B) includes one or more XDD symbols through the received first SFI. In the XDD symbol in the third slot, the terminal 820 may be able to simultaneously perform DL communication and UL communication with the base station 810.

According to an embodiment, when a valid duration has elapsed, the terminal 820 may receive a second SFI from the base station 810, and may identify that a fourth slot (e.g., the slot 2 of the cell 0 of FIG. 10B) includes one or more XDD symbols through the received second SFI. The received first SFI may be the same as or different from the received second SFI. In the XDD symbol in the fourth slot, the terminal 820 may be able to simultaneously perform DL communication and UL communication with the base station 810.

According to an embodiment, the valid duration may be determined based on a PDCCH monitoring period.

The embodiments described with reference to FIGS. 1 to 17 may apply to the embodiments described with reference to FIG. 18, and thus, a detailed description thereof is omitted.

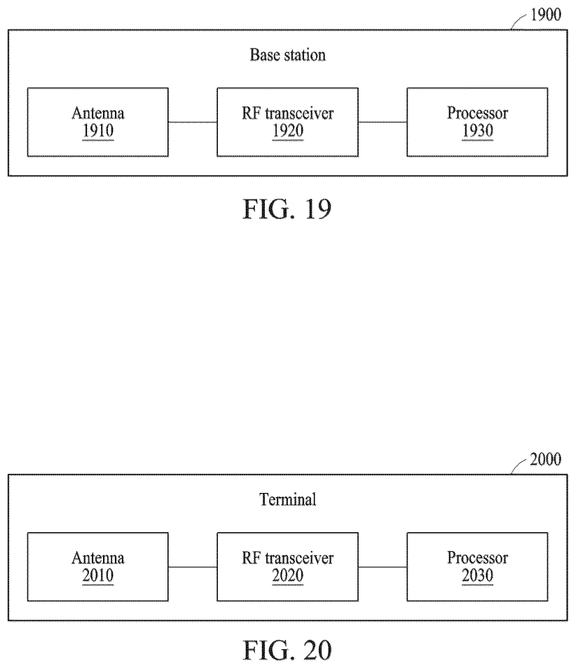

FIG. 19 is a block diagram illustrating a base station according to an embodiment.

Referring to FIG. 19, a base station 1900 (e.g., the base station 810 of FIG. 8) may include an antenna 1910, a radio frequency (RF) transceiver 1920, and a processor 1930. The base station 1900 may include at least one memory. The processor 1930 may correspond to at least one processor including or corresponding to circuitry like a central processing unit (CPU), a microprocessor unit (MPU), an application processor (AP), a coprocessor (CP), a system-on-chip (SoC), or an integrated circuit (IC).

According to an embodiment, the RF transceiver 1920 may transmit and receive a signal to or from the terminal 820 through the antenna 1910. The transmitted and received signal may include, for example, control information and data.

According to an embodiment, the RF transceiver 1920 may receive a baseband signal from the processor 1930, may convert the baseband signal into an RF signal, and may transmit the RF signal to the terminal 820 through the antenna 1910. The RF transceiver 1920 may receive an RF signal of the terminal 820 through the antenna 1910, may convert the RF signal into a baseband signal, and may transmit the baseband signal to the processor 1930.

According to an embodiment, the processor 1930 may cause a base station (e.g., the base station 810, 1900) to perform an operation.

According to an embodiment, the base station 1900 may transmit first DL BWP configuration information including an ID of a first DL BWP to the terminal 820. The base station 1900 may transmit first UL BWP configuration information including an ID of a first UL BWP to the terminal 820. The base station 1900 may transmit, to the terminal 820, second DL BWP configuration information including an ID of a second DL BWP and an ID of a second UL BWP for DL-UL configuration of the terminal 820. In a first slot, the first DL BWP and the first UL BWP may be temporally separated from each other and the base station 1900 and the terminal 820 may be unable to simultaneously perform DL communication and UL communication. In a second slot, the base station 1900 and the terminal 820 may be able to perform DL communication and UL communication based on the second DL BWP configuration information.

According to an embodiment, the base station 1900 may transmit UL DCI including a BWP indicator indicating the second UL BWP from the first slot to the terminal 820. If a DL BWP linked to the second UL BWP exists, a BWP change from the first UL BWP to the second UL BWP may be performed, a BWP change from the first DL BWP to the linked DL BWP may be performed, the second UL BWP may be activated in the second slot, and the DL BWP linked to the second UL BWP may be activated. If a DL BWP linked to the second UL BWP does not exist, a BWP change from the first UL BWP to the second UL BWP may be performed, the first DL BWP may be maintained, and the second UL BWP and the first DL BWP may be activated in the second slot.

According to an embodiment, a BWP change from the first UL BWP to the second UL BWP may be performed, and after a BWP change from the first DL BWP to the DL BWP linked to the second UL BWP is performed, a valid duration may elapse. In this case, a BWP change from the second UL BWP to the first UL BWP or an initial UL BWP may be performed, and a BWP change from the linked DL BWP to the first DL BWP or an initial DL BWP may be performed.

According to an embodiment, the base station 1900 may transmit DL DCI including a first feedback timing indicator corresponding to the second UL BWP from the first slot to the terminal 820. A BWP change from the first UL BWP to the second UL BWP may be performed and a BWP change from the first DL BWP to the DL BWP linked to the second UL BWP may be performed. When the valid duration has elapsed, a BWP change from the second UL BWP to the first UL BWP or the initial UL BWP may be performed, and a BWP change from the DL BWP to the first DL BWP or the initial DL BWP may be performed.

The embodiments described with reference to FIGS. 1 to 17 may apply to the embodiments described with reference to FIG. 19, and thus, a detailed description thereof is omitted.

FIG. 20 is a block diagram illustrating a terminal according to an embodiment.

Referring to FIG. 20, a terminal 2000 (e.g., the terminal 820 of FIG. 8) may include an antenna 2010, an RF transceiver 2020, and a processor 2030. The terminal 2000 may include at least one memory. The processor 2030 may correspond to at least one processor including or corresponding to circuitry like a CPU, a MPU, an AP, a CP, a SoC, or an IC.

According to an embodiment, the RF transceiver 2020 may transmit and receive a signal to or from the base station 810, 1900 through the antenna 2010. The transmitted and received signal may include, for example, control information and data.

According to an embodiment, the RF transceiver 2020 may receive a baseband signal from the processor 2030, may convert the baseband signal into an RF signal, and may transmit the RF signal to the base station 810, 1900 through the antenna 2010. The RF transceiver 2020 may receive an RF signal of the base station 810, 1900 through the antenna 2010, may convert the RF signal into a baseband signal, and may transmit the baseband signal to the processor 2030.

According to an embodiment, the processor 2030 may cause a terminal (e.g., the terminal 820, 2000) to perform an operation.

According to an embodiment, the processor 2030 may receive first DL BWP configuration information including an ID of a first DL BWP from the base station 810, 1900 through the antenna 2010 and the RF transceiver 2020. The processor 2030 may receive first UL BWP configuration information including an ID of a first UL BWP from the base station 810, 1900 through the antenna 2010 and the RF transceiver 2020. The processor 2030 may receive second DL BWP configuration information including an ID of a second DL BWP and an ID of a second UL BWP from the base station 810, 1900. The processor 1830 may recognize that the second DL BWP configuration information is information (e.g., XDD configuration information) for DL-UL configuration of the terminal 2000 through the ID of the second UL BWP.

The embodiments described with reference to FIGS. 1 to 19 may apply to the embodiments described with reference to FIG. 20, and thus, a detailed description thereof is omitted.

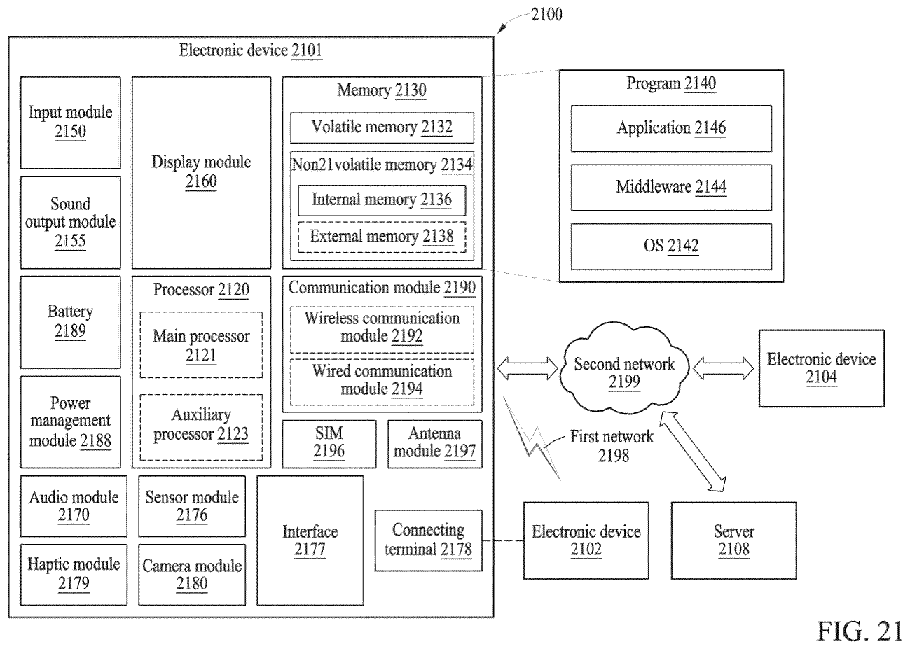

FIG. 21 is a block diagram illustrating an electronic device 2101 in a network environment 2100 according to an embodiment. The electronic device 2101 of FIG. 21 may correspond to an example of the terminal or the base station described with reference to FIGS. 1 to 20.

Referring to FIG. 21, the electronic device 2101 in the network environment 2100 may communicate with an electronic device 2102 via a first network 2198 (e.g., a short-range wireless communication network), or communicate with at least one of an electronic device 2104 or a server 2108 via a second network 2199 (e.g., a long-range wireless communication network). According to an embodiment, the electronic device 2101 may communicate with the electronic device 2104 via the server 2108. According to one embodiment, the electronic device 2101 may include a processor 2120, a memory 2130, an input module 2150, a sound output module 2155, a display module 2160, an audio module 2170, and a sensor module 2176, an interface 2177, a connecting terminal 2178, a haptic module 2179, a camera module 2180, a power management module 2188, a battery 2189, a communication module 2190, a subscriber identification module (SIM) 2196, or an antenna module 2197. In one embodiment, at least one (e.g., the connecting terminal 2178) of the above components may be omitted from the electronic device 2101, or one or more other components may be added in the electronic device 2101. In one embodiment, some (e.g., the sensor module 2176, the camera module 2180, or the antenna module 2197) of the components may be integrated as a single component (e.g., the display module 2160).

The processor 2120 may execute, for example, software (e.g., a program 2140) to control at least one other component (e.g., a hardware or software component) of the electronic device 2101 connected to the processor 2120, and may perform various data processing or computation. According to one embodiment, as at least a part of data processing or computation, the processor 2120 may store a command or data received from another component (e.g., the sensor module 2176 or the communication module 2190) in a volatile memory 2132, process the command or the data stored in the volatile memory 2132, and store resulting data in a non-volatile memory 2134. According to one embodiment, the processor 2120 may include a main processor 2121 (e.g., a central processing unit (CPU) or an application processor) or an auxiliary processor 2123 (e.g., a graphics processing unit (GPU), a neural processing unit (NPU), an image signal processor (ISP), a sensor hub processor, or a communication processor (CP)) that is operable independently of, or in conjunction with the main processor 2121. For example, when the electronic device 2101 includes the main processor 2121 and the auxiliary processor 2123, the auxiliary processor 2123 may be adapted to consume less power than the main processor 2121 or to be specific to a specified function. The auxiliary processor 2123 may be implemented separately from the main processor 2121 or as a part of the main processor 2121.

The auxiliary processor 2123 may control at least some of functions or states related to at least one (e.g., the display module 2160, the sensor module 2176, or the communication module 2190) of the components of the electronic device 2101, instead of the main processor 2121 while the main processor 2121 is in an inactive (e.g., sleep) state or along with the main processor 2121 while the main processor 2121 is in an active state (e.g., executing an application). According to one embodiment, the auxiliary processor 2123 (e.g., an ISP or a CP) may be implemented as a portion of another component (e.g., the camera module 2180 or the communication module 2190) that is functionally related to the auxiliary processor 2123. According to one embodiment, the auxiliary processor 2123 (e.g., an NPU) may include a hardware structure specified for artificial intelligence model processing. An AI model may be generated by machine learning. Such learning may be performed by, for example, the electronic device 2101 in which artificial intelligence is performed, or performed via a separate server (e.g., the server 2108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 2130 may store various data used by at least one component (e.g., the processor 2120 or the sensor module 2176) of the electronic device 2101. The various pieces of data may include, for example, software (e.g., the program 2140) and input data or output data for a command related thereto. The memory 2130 may include the volatile memory 2132 or the non-volatile memory 2134.

The program 2140 may be stored as software in the memory 2130 and may include, for example, an operating system (OS) 2142, middleware 2144, or an application 2146.

The input module 2150 may receive a command or data to be used by another component (e.g., the processor 2120) of the electronic device 2101, from the outside (e.g., a user) of the electronic device 2101. The input module 2150 may include, for example, a microphone, a mouse, a keyboard, a key (e.g., a button), or a digital pen (e.g., a stylus pen).

The sound output module 2155 may output a sound signal to the outside of the electronic device 2101. The sound output module 2155 may include, for example, a speaker or a receiver. The speaker may be used for general purposes, such as playing multimedia or playing record. The receiver may be used to receive an incoming call. According to one embodiment, the receiver may be implemented separately from the speaker or as a part of the speaker.

The display module 2160 may visually provide information to the outside (e.g., a user) of the electronic device 2101. The display module 2160 may include, for example, a display, a hologram device, or a projector and control circuitry to control a corresponding one of the display, the hologram device, and the projector. According to one embodiment, the display module 2160 may include a touch sensor adapted to sense a touch, or a pressure sensor adapted to measure an intensity of a force incurred by the touch.

The audio module 2170 may convert a sound into an electrical signal or vice versa. According to one embodiment, the audio module 2170 may obtain the sound via the input module 2150 or output the sound via the sound output module 2155 or an external electronic device (e.g., the electronic device 2102 such as a speaker or a headphone) directly or wirelessly connected to the electronic device 2101.

The sensor module 2176 may detect an operational state (e.g., power or temperature) of the electronic device 2101 or an environmental state (e.g., a state of a user) external to the electronic device 2101, and generate an electrical signal or data value corresponding to the detected state. According to one embodiment, the sensor module 2176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2177 may support one or more specified protocols to be used for the electronic device 2101 to be coupled with the external electronic device (e.g., the electronic device 2102) directly (e.g., by wire) or wirelessly. According to one embodiment, the interface 2177 may include, for example, a high-definition multimedia interface (HDMI), a universal serial bus (USB) interface, a secure digital (SD) card interface, or an audio interface.

The connecting terminal 2178 may include a connector via which the electronic device 2101 may be physically connected to an external electronic device (e.g., the electronic device 2102). According to one embodiment, the connecting terminal 2178 may include, for example, an HDMI connector, a USB connector, an SD card connector, or an audio connector (e.g., a headphone connector).

The haptic module 2179 may convert an electrical signal into a mechanical stimulus (e.g., a vibration or a movement) or an electrical stimulus which may be recognized by a user via his or her tactile sensation or kinesthetic sensation. According to one embodiment, the haptic module 2179 may include, for example, a motor, a piezoelectric element, or an electric stimulator.

The camera module 2180 may capture a still image and moving images. According to one embodiment, the camera module 2180 may include one or more lenses, image sensors, image signal processors, or flashes.

The power management module 2188 may manage power supplied to the electronic device 2101. According to one embodiment, the power management module 2188 may be implemented as, for example, at least a part of a power management integrated circuit (PMIC).

The battery 2189 may supply power to at least one component of the electronic device 2101. According to one embodiment, the battery 2189 may include, for example, a primary cell which is not rechargeable, a secondary cell which is rechargeable, or a fuel cell.

The communication module 2190 may support establishing a direct (e.g., wired) communication channel or a wireless communication channel between the electronic device 2101 and the external electronic device (e.g., the electronic device 2102, the electronic device 2104, or the server 2108) and performing communication via the established communication channel. The communication module 2190 may include one or more communication processors that are operable independently of the processor 2120 (e.g., an AP) and that support a direct (e.g., wired) communication or a wireless communication. According to one embodiment, the communication module 2190 may include a wireless communication module 2192 (e.g., a cellular communication module, a short-range wireless communication module, or a global navigation satellite system (GNSS) communication module) or a wired communication module 2194 (e.g., a local area network (LAN) communication module, or a power line communication (PLC) module). A corresponding one of these communication modules may communicate with the external electronic device 2104 via the first network 2198 (e.g., a short-range communication network, such as Bluetooth™, wireless-fidelity (Wi-Fi) direct, or infrared data association (IrDA)) or the second network 2199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 2192 may identify and authenticate the electronic device 2101 in a communication network, such as the first network 2198 or the second network 2199, using subscriber information (e.g., international mobile subscriber identity (IMSI)) stored in the SIM 2196.

The wireless communication module 2192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 2192 may support a high-frequency band (e.g., a mmWave band) to achieve, e.g., a high data transmission rate. The wireless communication module 2192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 2192 may support various requirements specified in the electronic device 2101, an external electronic device (e.g., the electronic device 2104), or a network system (e.g., the second network 2199). According to one embodiment, the wireless communication module 2192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 2197 may transmit or receive a signal or power to or from the outside (e.g., the external electronic device). According to one embodiment, the antenna module 2197 may include an antenna including a radiating element including a conductive material or a conductive pattern formed in or on a substrate (e.g., a printed circuit board (PCB)). According to one embodiment, the antenna module 2197 may include a plurality of antennas (e.g., array antennas). In such a case, at least one antenna appropriate for a communication scheme used in a communication network, such as the first network 2198 or the second network 2199, may be selected by, for example, the communication module 2190 from the plurality of antennas. The signal or power may be transmitted or received between the communication module 2190 and the external electronic device via the at least one selected antenna. According to one embodiment, another component (e.g., a radio frequency integrated circuit (RFIC)) other than the radiating element may be additionally formed as a part of the antenna module 2197.

According to various embodiments, the antenna module 2197 may form a mmWave antenna module. According to one embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one embodiment, commands or data may be transmitted or received between the electronic device 2101 and the external electronic device 2104 via the server 2108 coupled with the second network 2199. Each of the external electronic devices 2102 and 2104 may be a device of the same type as or a different type from the electronic device 2101. According to one embodiment, all or some of operations to be executed by the electronic device 2101 may be executed at one or more of the external electronic devices 2102, 2104, or 2108. For example, if the electronic device 2101 needs to perform a function or a service automatically, or in response to a request from a user or another device, the electronic device 2101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 2101. The electronic device 2101 may provide the result, with or without further processing the result, as at least part of a response to the request. To this end, cloud computing, distributed computing, mobile edge computing (MEC), or client-server computing technology may be used, for example. The electronic device 2101 may provide ultra low-latency services using, e.g., distributed computing or mobile edge computing. In one embodiment, the external electronic device 2104 may include an Internet-of-things (IoT) device. The server 2108 may be an intelligent server using machine learning and/or a neural network. According to one embodiment, the external electronic device 2104 or the server 2108 may be included in the second network 2199. The electronic device 2101 may be applied to intelligent services (e.g., a smart home, a smart city, a smart car, or healthcare) based on 5G communication technology or IoT-related technology.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to one embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and may refer to components in other aspects (e.g., importance or order) is not limited. It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to one embodiment, the module may be implemented in a form of an application-specific integrated circuit (ASIC).

Embodiments as set forth herein may be implemented as software (e.g., the program 2140) including one or more instructions that are stored in a storage medium (e.g., an internal memory 2136 or an external memory 2138) that is readable by a machine (e.g., the electronic device 2101). For example, a processor (e.g., the processor 2120) of the machine (e.g., the electronic device 2101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method performed by a terminal, comprising:
receiving, from a base station, first downlink (DL) bandwidth part (BWP) configuration information comprising an identifier (ID) of a first DL BWP;
receiving, from the base station, first uplink (UL) BWP configuration information comprising an ID of a first UL BWP;
receiving, from the base station, second DL BWP configuration information comprising an ID of a second DL BWP and an ID of a second UL BWP; and
recognizing, through the ID of the second UL BWP, that the second DL BWP configuration information is information for DL-UL configuration of the terminal,
wherein, in a first slot, when the first DL BWP and the first UL BWP are temporally separated from each other, DL communication and UL communication are not simultaneously performed, by the terminal, with the base station, and
wherein, in a second slot, the DL communication and the UL communication are simultaneously performed, by the terminal, with the base station based on the second DL BWP configuration information.

2. The method of claim 1, further comprising:
receiving, from the base station, UL downlink control information (DCI) in the first slot; and
when a BWP indicator in the received UL DCI indicates the second UL BWP, performing a first BWP change from the first UL BWP to the second UL BWP, and performing a second BWP change from the first DL BWP to a DL BWP linked to the second UL BWP,
wherein, in the second slot, the second UL BWP and the linked DL BWP are activated.

3. The method of claim 2, wherein the DL BWP linked to the second UL BWP is an initial UL BWP or a default UL BWP.

4. The method of claim 1, further comprising:
when UL DCI is received from the base station in the first slot and a BWP indicator in the received UL DCI indicates the second UL BWP, performing a first BWP change from the first UL BWP to the second UL BWP, and maintaining the first DL BWP, wherein, in the second slot, the second UL BWP and the first DL BWP are activated; or
when the BWP indicator in the received UL DCI indicates the second UL BWP, performing the first BWP change from the first UL BWP to the second UL BWP, performing a second BWP change from the first DL BWP to the DL BWP linked to the second UL BWP, and when a valid duration has elapsed, performing a third BWP change from the second UL BWP to the first UL BWP or an initial UL BWP, and performing a fourth BWP change from the link DL BWP to the first DL BWP or an initial DL BWP.

5. The method of claim 1, further comprising:
receiving DL DCI from the base station in the first slot;
when a first feedback timing indicator in the received DL DCI corresponds to the second UL BWP, performing a first BWP change from the first UL BWP to the second UL BWP, and performing a second BWP change from the first DL BWP to the DL BWP linked to the second UL BWP; and
when a valid duration has elapsed, performing a third BWP change from the second UL BWP to the first UL BWP or an initial UL BWP, and performing a fourth BWP change from the DL BWP to the first DL BWP or an initial DL BWP.

6. The method of claim 5, wherein the first feedback timing indicator is a physical downlink shared channel (PDSCH)-to-hybrid automatic repeat-request (HARQ) feedback timing indicator.

7. The method of claim 1, further comprising:
receiving DL DCI from the base station in the first slot;
when the first feedback timing indicator in the received DL DCI and a resource that transmits a report of channel state information correspond to the second UL BWP, performing a first BWP change from the first UL BWP to the second UL BWP, and performing a second BWP change from the first DL BWP to the DL BWP linked to the second UL BWP; and
when a valid duration comprising the second slot has elapsed, performing a third BWP change from the second UL BWP to the first UL BWP or an initial UL BWP and performing a fourth BWP change from the DL BWP to the first DL BWP or an initial DL BWP.

8. The method of claim 1, further comprising:
when an overlap between an allocated DL frequency resource and an allocated UL frequency resource occurs in the second slot, dropping one having a lower priority of the DL communication and the UL communication or performing rate matching on the lower priority; or
when an overlap between the allocated DL frequency resource and the allocated UL frequency resource occurs in the second slot, calculating a ratio of the overlapping frequency resource, dropping one having a lower priority of the DL communication and the UL communication when a calculated ratio exceeds a threshold value, and performing a rate matching on one having the lower priority of the DL communication and the UL communication.

9. The method of claim 1, further comprising:
receiving common configuration information on configuration of a UL resource and a DL resource from the base station, wherein the received common configuration information comprises a number of DL slots, a number of DL symbols, a number of cross division duplex (XDD) slots, a number of XDD symbols, a number of UL slots, a number of UL symbols, information on a frequency location and bandwidth of an XDD, and a parameter indicating whether the frequency location needs to be interpreted based on a center frequency location of a frequency band allocated to the terminal, and the terminal is able to simultaneously perform the DL communication and the UL communication with the base station in an XDD slot or an XDD symbol according to the received first common configuration information; or
receiving dedicated configuration information on configuration of a UL resource and a DL resource from the base station, wherein the received dedicated configuration information comprises an index of a slot configured as an XDD slot, and respective numbers of DL symbols, XDD symbols, and UL symbols comprised in the XDD slot, and the terminal is able to simultaneously perform the DL communication and the UL communication with the base station in the XDD slot.

10. The method of claim 1, further comprising:
receiving, from the base station, a first slot format indicator (SFI); and
identifying that a third slot comprises one or more XDD symbols through the received first SFI,
wherein, in the XDD symbol in the third slot, the DL communication and the UL communication are simultaneously performed, by the terminal, with the base station.

11. The method of claim 10, further comprising:
when a valid duration has elapsed, receiving a second SFI from the base station; and
identifying that a fourth slot comprises one or more XDD symbols through the received second SFI,
wherein the received first SFI is the same as or different from the received second SFI, and
wherein, in the XDD symbol in the fourth slot, the DL communication and the UL communication are performed simultaneously, by the terminal, with the base station.

12. The method of claim 11, wherein the valid duration is determined based on a physical downlink control channel (PDCCH) monitoring period.

13. A method performed by a base station, comprising:
transmitting first downlink (DL) bandwidth part (BWP) configuration information comprising an identifier (ID) of a first DL BWP to a terminal;
transmitting, to the terminal, first uplink (UL) BWP configuration information comprising an ID of a first UL BWP; and
transmitting, to the terminal, second DL BWP configuration information comprising an ID of a second DL BWP and an ID of a second UL BWP for DL-UL configuration of the terminal,
wherein, in a first slot, when the first DL BWP and the first UL BWP are temporally separated from each other, DL communication and UL communication are not simultaneously performed by the base station with the terminal, and
wherein, in a second slot, the DL communication and the UL communication are not simultaneously performed by the base station with the terminal based on the second DL BWP configuration information.

14. The method of claim 13, further comprising:
transmitting UL downlink control information (DCI) comprising a BWP indicator indicating the second UL BWP to the terminal from the first slot,
wherein, when a DL BWP linked to the second UL BWP exists, a first BWP change from the first UL BWP to the second UL BWP is performed, a fourth BWP change from the first DL BWP to the linked DL BWP is performed, and in the second slot, the second UL BWP and the linked DL BWP are activated, and
wherein, when a DL BWP linked to the second UL BWP does not exist, the first BWP change from the first UL BWP to the second UL BWP is performed, the first DL BWP is maintained, and in the second slot, the second UL BWP and the first DL BWP are activated.

15. The method of claim 13, further comprising transmitting UL DCI comprising a BWP indicator indicating the second UL BWP to the terminal from the first slot, wherein a first BWP change from the first UL BWP to the second UL BWP is performed, a second BWP change from the first DL BWP to a DL BWP linked to the second UL BWP is performed, and when a valid duration has elapsed, a third BWP change from the second UL BWP to the first UL BWP or an initial UL BWP is performed, and a fourth BWP change from the linked DL BWP to the first DL BWP or an initial DL BWP is performed.

16. The method of claim 13, further comprising transmitting DL DCI comprising a first feedback timing indicator corresponding to the second UL BWP to the terminal from the first slot, wherein the first BWP change from the first UL BWP to the second UL BWP is performed, the second BWP change from the first DL BWP to a DL BWP linked to the second UL BWP is performed, and when a valid duration has elapsed, the third BWP change from the second UL BWP to the first UL BWP or an initial UL BWP is performed, and the fourth BWP change from the DL BWP to the first DL BWP or an initial DL BWP is performed.
